(19) United States
(12) Patent Application Publication
(10) Pub. No.: US 2011/0285783 A1
(43) Pub. Date: Nov. 24, 2011

(54) LIQUID JETTING HEAD, LIQUID JETTING RECORDING APPARATUS, AND METHOD FOR FILLING LIQUID JETTING HEAD WITH LIQUID

(76) Inventors: Akifumi Sakata, Chiba (JP); Kazuyoshi Tominaga, Chiba (JP); Toshiaki Watanabe, Chiba (JP); Ayako Kayama, Chiba (JP)

(21) Appl. No.: 12/998,951

(22) PCT Filed: Oct. 16, 2009
(86) PCT No.: PCT/JP2009/067916

§ 371 Date: Jul. 18, 2011

(30) Foreign Application Priority Data
Dec. 17, 2008 (JP) 2008-32079 2008

(51) Int. Cl. B41J 2/165

(52) U.S. Cl. 347/30

(57) ABSTRACT

A liquid jet head including: a wall portion (24) which surrounds a jetting hole column and protrudes in the same direction as a direction of openings of jetting holes; a lid member (62) which may open and close an opening formed in the wall portion; an opening and closing mechanism (60) for forming closed space between the wall portion and a jetting body (23) and for, in an open state, exposing the jetting holes to the outside; an absorber (40) provided on a back surface of the lid member, for absorbing liquid which overflows from the jetting holes; a suction flow path (15) which has a suction port (15a) that is open to the closed space and which is connected to an outside suction device (8); and an atmosphere release portion (33) which is switchable between release of the closed space to the outside and interruption thereof.

### TECHNICAL FIELD

The present invention relates to a liquid jet head for jetting liquid from liquid nozzles to record an image or text on a recording medium, a liquid jet recording apparatus, and a method of filling liquid into a liquid jet head.

### BACKGROUND ART

Generally, a liquid jet recording apparatus, for example, an ink jet printer which carries out various kinds of printing, includes a transfer apparatus for transferring a recording medium and an ink jet head. As an ink jet head used here, there is known an ink jet head including a nozzle body (jetting body) having a nozzle column (jetting hole column) formed of a plurality of nozzle holes (jetting holes), a plurality of pressure generating chambers which are paired with and communicate with the nozzle holes, respectively, an ink supply system for supplying ink to the pressure generating chambers, and a piezoelectric actuator disposed adjacent to the pressure generating chambers, in which the piezoelectric actuator is driven to pressurize the pressure generating chambers to cause ink in the pressure generating chambers to be discharged from nozzle orifices in the nozzle holes.

As a kind of such an ink jet printer, there is known an ink jet printer in which a carriage for moving the ink jet head in a direction orthogonal to the direction of transfer of recording paper (recording medium) is provided and printing is carried out on the recording paper. In an ink jet printer of such a kind, a service station for maintenance is provided in a movable range of the ink jet head, and the ink jet head is moved to the service station at which the nozzle holes are cleaned and the ink jet head is capped and sucked under negative pressure to initially fill the nozzle holes with ink (so-called suction filling). For example, Patent Documents 1 and 2 described below disclose a structure in which ink in ink orifices of a recording head is sucked by a suction pump connected to a cap under a state in which the recording head and the cap is in abutment with each other.

An ink jet printer of a kind which is different from the kind of the above-mentioned ink jet printer is used for a relatively large-sized recording medium such as a box and carries out printing on a recording medium which is transferred with an ink jet head being fixed. In an ink jet printer of this kind, the ink jet head cannot be moved, and there is not enough space for providing a service station between the ink jet head and a recording medium or below the ink jet head. Therefore, when the pressure generating chambers are initially filled with ink, ink is normally pressurized from the side of the ink supply system during being filled.

In this pressurized filling, in order to prevent contamination of the ink jet head and of places in proximity to the ink jet printer with excess ink which droops from the nozzle holes, and in order to prevent unstable discharge of ink after the filling of the ink, it is necessary to take measures of removing excess ink. As such measures, for example, as described in Patent Document 2, a structure is disclosed in which an ink guide member that is formed of a plate-like porous absorber and protrudes outward from a nozzle formation surface and a block-shaped absorber connected to the ink guide member are provided below the ink jet head, excess ink is received and guided to the absorber by the ink guide member, and the guided excess ink is absorbed by the absorber.

Patent Document 1: JP 06-218938 A

Patent Document 2: JP 05-116338 A

### DISCLOSURE OF THE INVENTION

### Problem to be Solved by the Invention

However, in the structure disclosed in Patent Document 2, there is a problem in that, because the ink guide member and the absorber are provided below the ink jet head, space below the ink jet head may not be effectively used. Another problem is in that, therefore, printing cannot be carried out on a lower portion of a recording medium. Still another problem is in that, because the ability to collect excess ink is insufficient, places around the head become dirty.

The present invention has been made in view of the above, and objects of the present invention are as follows:
(1) to improve a space factor of a liquid jet head to improve flexibility in designing a liquid jet recording apparatus; and
(2) to improve ability to collect excess liquid with a simple structure to prevent contamination with excess liquid and to achieve initial filling of a liquid jet recording apparatus to stabilize jetting of liquid after the liquid is filled.

### Means for Solving the Problems

In order to achieve the objects described above, the present invention adopts the following means.

As solving means related to a liquid jet head, there is adopted means in which a liquid jet head including a jetting body having a jetting hole column formed of a plurality of jetting holes, a plurality of pressure generating chambers which are paired with and communicate with the plurality of jetting holes, respectively, a liquid supply system for supplying a first liquid to the plurality of pressure generating chambers and the plurality of jetting holes, and an actuator disposed adjacent to the plurality of pressure generating chambers, the actuator being driven to pressurize the plurality of pressure generating chambers, thereby causing the first liquid to be jetted from liquid nozzles of the plurality of jetting holes, the liquid jet head includes: a wall portion provided so as to surround the jetting body and having an opening opposed to the plurality of jetting holes; an opening and closing mechanism having a lid member which is capable of opening and closing the opening formed by the wall portion, for, in a closed state, closing the opening to form closed space inside the wall portion and for, in an open state, releasing the opening to expose the plurality of jetting holes to outside; an absorber provided on a back surface of the lid member, for absorbing the first liquid which overflows from the plurality of jetting holes; a suction flow path which has a suction port that is open to an inside of the wall portion to communicate with the closed space and which is connected to an outside suction apparatus; and an atmosphere release portion which is switchable between release of the closed space to the outside and interruption thereof.

According to the structure, by closing the opening in the wall portion with the opening and closing mechanism, the first liquid may be filled and excess liquid which flows out of the jetting body may be collected only through suction with a sucking portion via the suction flow path provided below the jetting hole column.

More specifically, with space between the wall portion and the jetting body being closed space by closing the opening, by sucking with the suction device air in the closed space, the closed space is depressurized to be a negative pressure chamber. This causes the first liquid to flow from a supply source of the first liquid into the jetting body, and thus, suction filling of the first liquid may be carried out. Further, by closing the opening, excess liquid which flows out of the jetting body in filling the first liquid may be prevented from flowing out of the opening. By, after the first liquid is filled, sucking air in the closed space with the suction device via the suction flow path with the atmosphere release portion being released, air passes via the atmosphere release portion from the outside toward the closed space, and thus, the first liquid of the supply source is not sucked and the pressure in the closed space recovers. After that, the air which flows from the outside into the closed space is discharged to the outside via the suction flow path. Here, excess liquid which flows out of the jetting body and accumulates in the closed space is, together with the air which passes through the closed space, discharged to the outside.

Further, because the absorber is provided on a back surface of the lid member, for example, excess liquid which scatters during suction filling of the first liquid and excess liquid which is not completely sucked with the suction device are absorbed by the absorber. This may suppress flowing out of excess liquid to the outside when the lid member is opened and closed. Therefore, compared with a case in which the absorber is not provided on the back surface of the lid member, the ability to collect excess liquid may be further improved, and contamination with excess liquid may be prevented more reliably.

Therefore, contamination with excess liquid may be prevented with a simple structure and initial filling of the liquid jet recording apparatus may be achieved without providing a complicated service station as in a conventional case. Accordingly, jetting of the liquid after the liquid is filled may also be stabilized. Further, because excess liquid may be collected in the space inside the wall portion (closed space), the ability to collect excess liquid may be improved, and still, space used for collecting excess liquid may be extremely small to improve the space factor of the liquid jet head. This may improve the flexibility in designing the liquid jet recording apparatus.

Further, as solving means related to the liquid jet head, there is adopted means in which, when the jetting hole column is disposed in the vertical direction, the suction port is open below the jetting hole column in the jetting body, and the atmosphere release portion is provided above and along a direction of arrangement of the jetting hole column.

According to the structure, by providing the atmosphere release portion above and providing the suction port below, air passes from above to below (toward the suction port) in the closed space, and thus, excess liquid in the closed space may be sucked reliably. Further, because excess liquid which flows out of the jetting body droops down in the direction of gravity from the jetting body, by providing the atmosphere release portion above, even if the atmosphere release portion is released when excess liquid accumulates in the closed space, the excess liquid is prevented from flowing out of the atmosphere release portion, and still, the closed space and the outside may communicate with each other.

Further, as solving means related to the liquid jet head, there is adopted means in which the opening and closing mechanism includes a hinge portion for supporting the lid member, and the lid member is capable of opening and closing the opening with the hinge portion being the center of rotation.

According to the structure, by rotating the lid member via the hinge portion, opening and closing operation of the lid member may be carried out smoothly. By depressurizing the closed space between the wall portion and the jetting body under this state, the closed space may reliably be a negative pressure chamber, and the ability to collect excess liquid may be improved.

Further, as solving means related to the liquid jet head, there is adopted means in which the opening and closing mechanism is formed so that the lid member is slidable along an opening surface of the liquid nozzles in the jetting body.

According to the structure, because the opening may be opened and closed by sliding the lid member, compared with the structure in which the opening is opened and closed by rotating the lid member, the movable range of the opening and closing mechanism in the direction of the normal to the opening surface of the liquid nozzles is small. More specifically, space used for placing the opening and closing mechanism may be reduced, and further, the distance between a recording medium and the liquid nozzles may be reduced, and thus, the space factor may be further improved to improve the flexibility in designing the liquid jet recording apparatus.

Further, as solving means related to the liquid jet head, there is adopted means in which the lid member is formed to be slidable in a direction which intersects the direction of arrangement of the jetting hole column.

According to the structure, when the jetting hole column is disposed in the vertical direction, the lid member does not move downward. This eliminates the necessity to provide below the jetting body space for the lid member to move. Therefore, compared with a case in which the lid member is formed to be slidable in the direction of arrangement of the jetting hole column, the jetting hole column may be located lower. Accordingly, the space factor may be further improved to improve the flexibility in designing the liquid jet recording apparatus.

Further, as solving means related to the liquid jet head, there is adopted means in which the opening and closing mechanism is formed so that the lid member is slidable in the direction of arrangement of the jetting hole column.

According to the structure, it is also possible to stop the lid member in an engaged state halfway through the slide to be held with only an upper end portion of the opening being released. In this case, by releasing only the upper end portion of the opening from a state in which the opening is completely closed, the closed space between the wall portion and the jetting body communicates with the outside to be released to the atmosphere. More specifically, the opening and closing mechanism may serve as the atmosphere release portion, which eliminates the necessity to provide the atmosphere release portion separately. Therefore, the closed space may be released to the atmosphere without providing a valve or the like for the release to the atmosphere and without leakage of excess liquid which accumulates in the closed space. This allows a simpler structure of the liquid jet head to reduce the manufacturing cost.

Further, as solving means related to the liquid jet head, there is adopted means in which the lid member is flexible, and the opening and closing mechanism is formed so that the lid member is slidable in a direction which intersects the direction of arrangement of the jetting hole column below the jetting body in a direction of gravity and so that the lid member is slidable from below to above in the direction of gravity.

According to the structure, even if the lid member is formed to be slidable in the direction of arrangement of the jetting hole column, the movable space of the lid member below the jetting body may be made minimum. Therefore, the space factor of the liquid jet head may be further improved to improve the flexibility in designing the liquid jet recording apparatus.

Further, as solving means related to the liquid jet head, there is adopted means in which the absorber is provided, of a back surface of the lid member, on a whole of a surface which is exposed to the closed space in the closed state of the opening and closing mechanism.

According to the structure, because the absorber is provided on the whole of the surface which is exposed to the closed space of the back surface of the lid member, in particular, during suction filling of the first liquid, the whole excess liquid which scatters toward the lid member is absorbed by the absorber. This may suppress more effectively an outflow to the outside of excess liquid when the lid member is opened and closed. Therefore, the ability to collect excess liquid may be further improved, and contamination with excess liquid may be prevented more reliably.

Further, as solving means related to the liquid jet head, there is adopted means in which the absorber includes a wiper portion capable of being in sliding contact with a periphery of the liquid nozzles of the jetting body during opening and closing operation.

According to the structure, because the wiper portion is in sliding contact with the surface of the jetting body following sliding operation (opening and closing operation) of the lid member, excess liquid attached to the surface of the jetting body and excess liquid which protrudes from the nozzles of the jetting holes due to surface tension may be collected at the same time of opening and closing the lid member. This makes it possible to effectively use the space inside the wall portion to improve the space factor. Further, because a wiper effect may be produced simultaneously with the opening and closing operation of the lid member, the operating efficiency may be improved without separately providing a wiping step after the first liquid is filled.

Further, as solving means related to the liquid jet head, there is adopted means in which a groove portion is provided in a contact surface of the absorber with the lid member, for forming a drainage flow path together with the back surface of the lid member, and at least a part of the suction port is open to the groove portion.

According to the structure, because at least a part of the suction port is open to the groove portion, in the closed space formed inside the wall portion, the extent of negative pressure in the groove portion forming the drainage flow path together with the back surface of the lid member is higher than that in other places. This causes excess liquid absorbed by the absorber to, after flowing out to a ring-shaped flow path, flow through the ring-shaped flow path toward the suction port to be promptly discharged to the outside.

Because the ability of the absorber to absorb liquid may be promptly restored, the ability to collect excess liquid may be further improved, and contamination with excess liquid may be prevented more reliably.

Further, as solving means related to the liquid jet head, there is adopted means in which the groove portion is formed so as to surround the jetting hole column and so as to be ring-shaped viewed from a direction of openings of the plurality of jetting holes in the closed state of the opening and closing mechanism.

According to the structure, because the drainage flow path is formed so as to surround the jetting hole column and so as to be ring-shaped, excess liquid of the absorber is caused to flow out to the drainage flow path from all directions on the plane to be discharged to the outside. This may restore the ability of the absorber to absorb liquid efficiently over a wide range.

Further, as solving means related to the liquid jet head, there is adopted means in which the groove portion is linearly formed so as to overlap the jetting hole column viewed from a direction of openings of the plurality of jetting holes in the closed state of the opening and closing mechanism.

According to the structure, because the groove portion is linearly formed so as to overlap the jetting hole column, excess liquid at a portion of the absorber which is opposed to the liquid nozzles and which is easy to absorb excess liquid is intensively caused to flow out to the drainage flow path to be promptly discharged to the outside. This may promptly restore the ability of the absorber to absorb liquid.

Further, as solving means related to the liquid jet head, there is adopted means in which the groove portion is formed so as to surround the jetting hole column and so as to be U-shaped viewed from a direction of openings of the plurality of jetting holes in the closed state of the opening and closing mechanism.

According to the structure, because the drainage flow path is formed so as to surround the jetting hole column and so as to be U-shaped, excess liquid which droops down from a portion of the absorber which is opposed to the liquid nozzles and which is easy to absorb excess liquid is caused to flow out to the drainage flow path to be discharged to the outside. This may efficiently restore the ability of the absorber to absorb liquid.

Further, as solving means related to the liquid jet head, there is adopted means in which the absorber is disposed so as to fill whole space between the lid member and the jetting body in the closed state of the opening and closing mechanism and the absorber has a communicating portion provided at a place therein which is opposed to the jetting hole column, for communicating with the atmosphere release portion.

According to the structure, because the absorber is disposed so as to fill the whole space between the lid member and the jetting body, the absorber absorbs a large amount of liquid. This may extremely enhance the ability of the absorber to absorb liquid, and the amount of collected excess liquid may be further improved and contamination with excess liquid may be prevented more reliably.

Further, because the communicating portion is formed at a place in the absorber which is opposed to the jetting hole column, the liquid nozzles and the absorber are not brought into contact with each other. This prevents excess liquid absorbed by the absorber from flowing back to the jetting holes and prevents the liquid nozzles from being damaged, and jetting of the liquid after the liquid is filled may be stabilized.

Further, the shape of the surface of the liquid (meniscus) in the liquid nozzles after the liquid is filled may be formed with stability, and jetting of the liquid after the liquid is filled may be stabilized.

As solving means related to a liquid jet recording apparatus, there is adopted means in which a liquid jet recording apparatus includes: any one of the above-mentioned liquid jet heads; and a liquid supply portion for supplying the first liquid to the liquid supply system.

According to the structure, because any one of the above-mentioned liquid jet heads is included, various kinds of requirements as to the design of the liquid jet recording apparatus may be met, and, for example, the liquid jet recording apparatus may carry out recording on a lower portion of a recording medium.

Further, because the ability to collect excess liquid is extremely strong and, even if a large amount of excess liquid flows out, contamination with excess liquid is prevented and jetting of the liquid after the liquid is filled is stabilized, recording on a recording medium may be high-quality and highly efficient.

Further, because it is not necessary to clean a nozzle formation surface with a wiper, and, in addition, the wall portion material, the opening and closing mechanism, the suction flow path, and the outside suction device may collect excess liquid without providing a service station, initial filling may be achieved with a simple structure and the whole structure of the apparatus may be compact in size.

Further, as solving means related to the liquid jet recording apparatus, there is adopted means in which the liquid supply portion is formed to be capable of switchedly supplying the first liquid and a second liquid to the liquid supply system.

According to the structure, because two kinds of liquid are supplied to the liquid supply system, for example, ink and a cleaning liquid may be switchedly supplied to the liquid supply system to reduce the labor of cleaning the liquid jet head and to carry out the cleaning efficiently.

Further, as solving means related to the liquid jet recording apparatus, there is adopted means in which any one of the liquid jet recording apparatuses adopting the above-mentioned solving means further includes a reuse liquid supply system for collecting by sucking the first liquid which overflows in the negative pressure chamber and for supplying the first liquid to the plurality of pressure generating chambers.

According to the present invention, the first liquid which overflows in the negative pressure chamber may be reused.

Further, as solving means related to the liquid jet recording apparatus, there is adopted means in which, in any one of the liquid jet recording apparatuses adopting the above-mentioned solving means, the reuse liquid supply system includes a filter portion or a deaerator.

According to the present invention, liquid in an appropriate state may be reused.

Further, as solving means related to a method of filling liquid into a liquid jet head, there is adopted means in which a method of filling liquid into a liquid jet head, the liquid jet head including a jetting body having a jetting hole column formed of a plurality of jetting holes, a plurality of pressure generating chambers which are paired with and communicate with the plurality of jetting holes, respectively, a liquid supply system for supplying a first liquid to the plurality of pressure generating chambers and the plurality of jetting holes, and an actuator disposed adjacent to the plurality of pressure generating chambers, the actuator being driven to pressurize the plurality of pressure generating chambers, thereby causing the first liquid to be jetted from liquid nozzles of the plurality of jetting holes, the liquid jet head including: a wall portion provided so as to surround the jetting body and having an opening opposed to the plurality of jetting holes; an opening and closing mechanism having a lid member which is capable of opening and closing the opening formed by the wall portion, for, in a closed state, closing the opening to form closed space inside the wall portion and for, in an open state, releasing the opening to expose the plurality of jetting holes to outside; an absorber provided on a back surface of the lid member, for absorbing the first liquid which overflows from the plurality of jetting holes; a suction flow path which has a suction port that is open to an inside of the wall portion to communicate with the closed space and which is connected to an outside suction device; and an atmosphere release portion which is switchable between release of the closed space to the outside and interruption thereof, the method of filling liquid into a liquid jet head includes the steps of: in the closed state of the opening and closing mechanism, carrying out interruption by the atmosphere release portion and carrying out suction filling of the first liquid from the supply source into the plurality of pressure generating chambers and the plurality of jetting holes by the outside suction device via the suction flow path; and after the filling of the first liquid, in the closed state of the opening and closing mechanism, releasing the atmosphere release portion and sucking by the outside suction device an excess of the first liquid existing in the closed space.

According to the structure, by closing the opening in the wall portion with the opening and closing mechanism, the first liquid may be filled and excess liquid which flows out of the jetting body may be collected only through suction with a suction device via the suction flow path provided below the jetting hole column.

More specifically, with space between the wall portion and the jetting body being closed space by closing the opening, by sucking with the suction device air in the closed space, the closed space is depressurized to be a negative pressure chamber. This causes the first liquid to flow from the supply source of the first liquid into the jetting body, and thus, suction filling of the first liquid may be carried out. Further, by closing the opening, excess liquid which flows out of the jetting body in filling the first liquid may be prevented from flowing out of the opening. By, after the first liquid is filled, sucking air in the closed space with the suction device via the suction flow path with the atmosphere release portion being released, air passes via the atmosphere release portion from the outside toward the closed space, and thus, the first liquid of the supply source is not sucked and the pressure in the closed space recovers. After that, the air which flows from the outside into the closed space is discharged to the outside via the suction flow path. Here, excess liquid which flows out of the jetting body and accumulates in the closed space is, together with the air which passes through the closed space, discharged to the outside.

Further, because the absorber is provided on the back surface of the lid member, for example, excess liquid which scatters during suction filling of the first liquid and excess liquid which is not completely sucked with the suction device are absorbed by the absorber. This may suppress flowing out of excess liquid to the outside when the lid member is opened and closed. Therefore, compared with a case in which the absorber is not provided on the back surface of the lid member, the ability to collect excess liquid may be further improved, and contamination with excess liquid may be prevented more reliably.

Therefore, contamination with excess liquid may be prevented with a simple structure and initial filling of the liquid jet recording apparatus may be achieved without providing a complicated service station as in a conventional case. Accordingly, jetting of the liquid after the liquid is filled may also be stabilized. Further, because excess liquid may be collected in the space inside the wall portion (closed space), the ability to collect excess liquid may be improved, and still, space used for collecting excess liquid may be extremely small to improve the space factor of the liquid jet head. This may improve the flexibility in designing the liquid jet recording apparatus.

### Effects of the Invention

According to the present invention, by closing the opening in the wall portion with the opening and closing mechanism, the first liquid may be filled and excess liquid which flows out of the jetting body may be collected only through suction with the suction device via the suction flow path provided below the jetting hole column.

More specifically, with space between the wall portion and the jetting body being closed space by closing the opening, by sucking with the suction device air in the closed space, the closed space is depressurized to be a negative pressure chamber. This causes the first liquid to flow from the supply source of the first liquid into the jetting body, and thus, suction filling of the first liquid may be carried out. Further, by closing the opening, excess liquid which flows out of the jetting body in filling the first liquid may be prevented from flowing out of the opening. By, after the first liquid is filled, sucking air in the closed space with the suction device via the suction flow path with the atmosphere release portion being released, air passes via the atmosphere release portion from the outside toward the closed space, and thus, the first liquid of the supply source is not sucked and the pressure in the closed space recovers. After that, the air which flows from the outside into the closed space is discharged to the outside via the suction flow path. Here, excess liquid which flows out of the jetting body and accumulates in the closed space is, together with the air which passes through the closed space, discharged to the outside.

Further, because the absorber is provided on the back surface of the lid member, for example, excess liquid which scatters during suction filling of the first liquid and excess liquid which is not completely sucked with the suction device are absorbed by the absorber. This may suppress flowing out of excess liquid to the outside when the lid member is opened and closed. Therefore, compared with a case in which the absorber is not provided on the back surface of the lid member, the ability to collect excess liquid may be further improved, and contamination with excess liquid may be prevented more reliably.

Therefore, contamination with excess liquid may be prevented with a simple structure and initial filling of the liquid jet recording apparatus may be achieved without providing a complicated service station as in a conventional case. Accordingly, jetting of the liquid after the liquid is filled may also be stabilized. Further, because excess liquid may be collected in the space inside the wall portion (closed space), the ability to collect excess liquid may be improved, and still, space used for collects excess liquid may be extremely small to improve the space factor of the liquid jet head. This may improve the flexibility in designing the liquid jet recording apparatus.

### BRIEF DESCRIPTION OF THE DRAWINGS

FIG. 1 is a perspective view illustrating an ink jet recording apparatus 1 according to an embodiment of the present invention.

FIG. 2 is a schematic structural view of the ink jet recording apparatus 1 according to the embodiment of the present invention.

FIG. 3 is a front view of an ink jet head 10 according to a first embodiment of the present invention.

FIG. 4 is a schematic structural view of the ink jet head 10 viewed from a right side according to the first embodiment of the present invention, in which a part of the structure is in section.

FIG. 5 is a sectional view taken along the line I-I of FIG. 4 in the first embodiment of the present invention. It is to be noted that, in the illustrated ink jet head 10, an opening and closing mechanism 60 to be described later is in an open state.

FIG. 6 is an exploded perspective view of a head chip 20 according to the embodiment of the present invention.

FIG. 7 is an exploded perspective view illustrating details of a ceramic piezoelectric plate 21 and an ink chamber plate 22 according to the embodiment of the present invention.

FIG. 8 is an enlarged sectional view of a principal part of the ink jet head 10 according to the first embodiment of the present invention, which is an enlarged view corresponding to FIG. 5.

FIG. 9 shows graphs of a relationship among operation timing of a suction pump 16, operation timing of an atmosphere release valve, operation timing of an opening and closing mechanism (door), and space S (negative pressure chamber R) according to the embodiment of the present invention.

FIG. 10 are enlarged sectional views of a principal part of the head chip 20 illustrating operation of initial filling according to the embodiment of the present invention.

FIG. 11 are enlarged sectional views of a principal part of the head chip 20 illustrating operation of initial filling according to the embodiment of the present invention. FIG. 10A is a sectional view taken along the line IIa-IIa of FIG. 10B, while FIG. 11B is a sectional view taken along the line IIb-IIb of FIG. 10C.

FIG. 12 illustrate modified examples of the first embodiment of the present invention. FIG. 12A is an enlarged sectional view of a principal part of an ink jet head 70, while FIG. 12B is an enlarged sectional view of a principal part of an ink jet head 80.

FIG. 13 illustrates modified examples of the ink jet head 10 according to the first embodiment of the present invention and is a front view of an ink jet head 90 (95).

FIG. 14 are enlarged sectional views of a principal part of the ink jet head 90 (95) as modified examples of the first embodiment of the present invention. FIG. 14A is a sectional view taken along the line IIIa-IIIa of FIG. 13, while FIG. 14B is a sectional view taken along the line IIIb-IIIb of FIG. 13.

FIG. 15 illustrates a schematic structure of an ink jet head 100 according to a second embodiment of the present invention viewed from a right side, in which a part of the structure is in section.

FIG. 16 is an enlarged sectional view of a principal part of the ink jet head 100 according to the second embodiment of the present invention, which is a sectional view taken along the line IV-IV of FIG. 15.

FIG. 17 is an enlarged sectional view of a principal part of an ink jet head 200 according to a third embodiment of the present invention.

FIG. 18 illustrates a modified example of the ink jet head 200 according to the third embodiment of the present invention and is an enlarged sectional view of a principal part of an ink jet head 270.

### BEST MODES FOR CARRYING OUT THE INVENTION

Embodiments of the present invention are described in the following with reference to the attached drawings.

### First Embodiment

### (Liquid Jet Recording Apparatus)

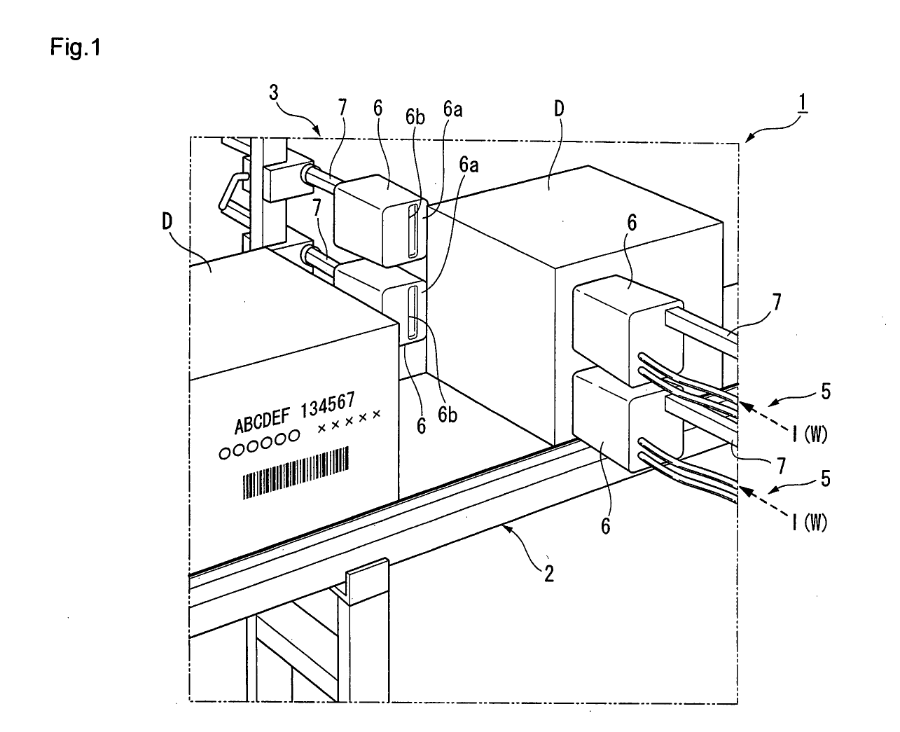

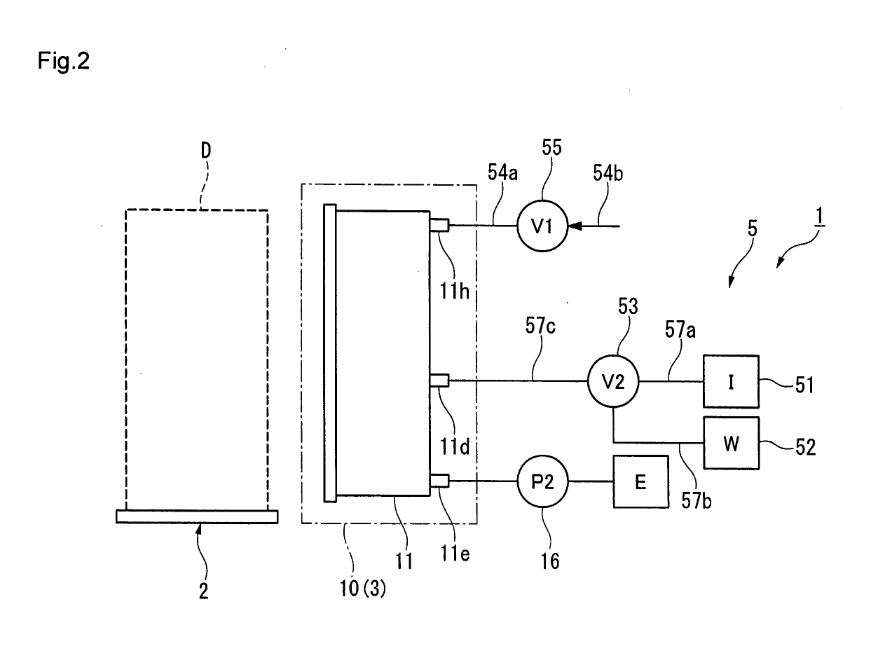

FIG. 1 is a perspective view illustrating an ink jet recording apparatus (liquid jet recording apparatus) 1 according to a first embodiment of the present invention. FIG. 2 is a schematic structural view of the ink jet recording apparatus 1. The ink jet recording apparatus 1 is connected to a predetermined personal computer, and carries out printing on a box D by, based on print data sent from the personal computer, discharging (jetting) ink (first liquid) I. The ink jet recording apparatus 1 includes a belt conveyor 2 for transferring the box D in one direction, an ink discharging portion 3 including a plurality of ink jet heads 10, an ink supply portion 5 for, as illustrated in FIG. 2, supplying the ink I and a cleaning liquid (second liquid) W to the ink jet head 10, and a suction pump (suction device) 16 connected to the ink jet head 10.

The ink discharging portion 3 discharges the ink I to the box D, and, as illustrated in FIG. 1, includes four enclosures 6 in the shape of rectangular parallelepipeds. The ink jet heads 10 are placed in the enclosures 6, respectively (see FIG. 2). The enclosures 6 are disposed in pairs on both sides of the belt conveyor 2 in a width direction with ink discharge surfaces 6a thereof being oriented to the belt conveyor 2 side, respectively. Two of the enclosures 6 disposed on both sides of the belt conveyor 2 in the width direction are vertically aligned with the other two of the enclosures 6 and all the enclosures 6 are supported by support members 7, respectively. It is to be noted that an opening 6b is formed in the ink discharge surface 6a of the enclosure 6.

(Liquid Jet Head)

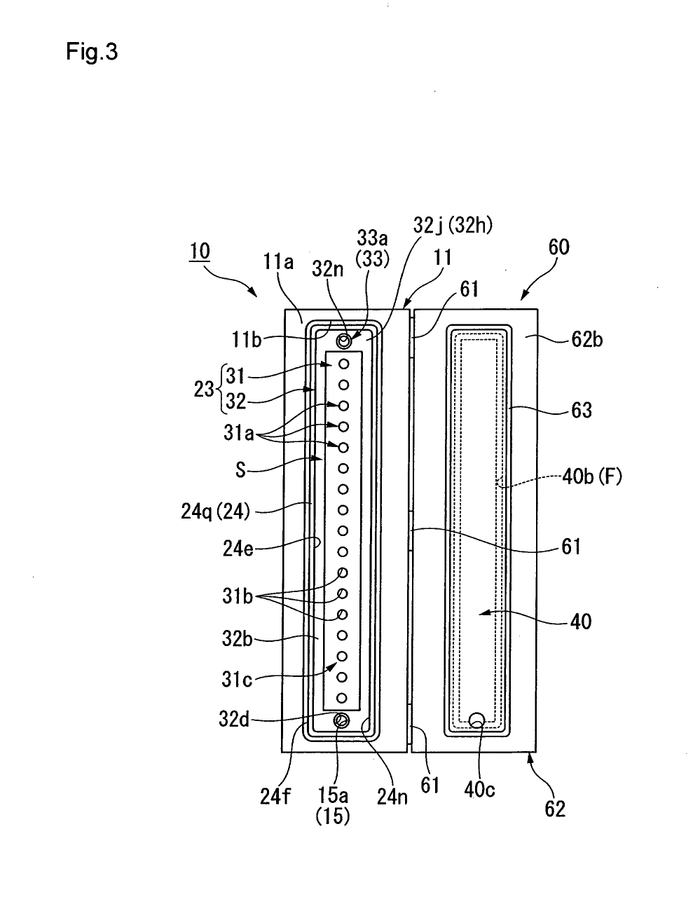

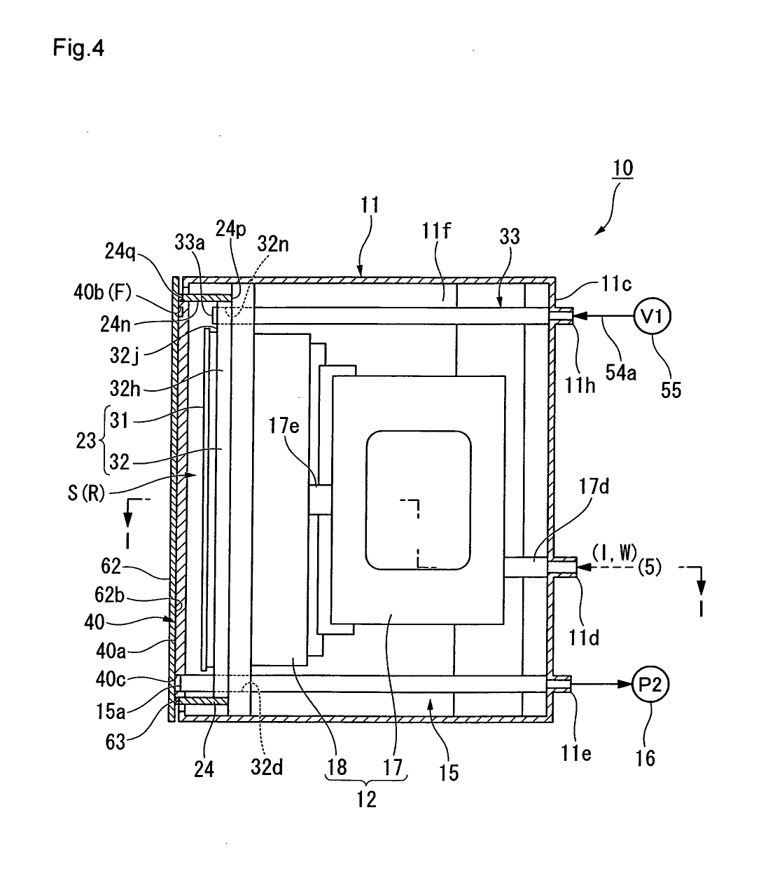

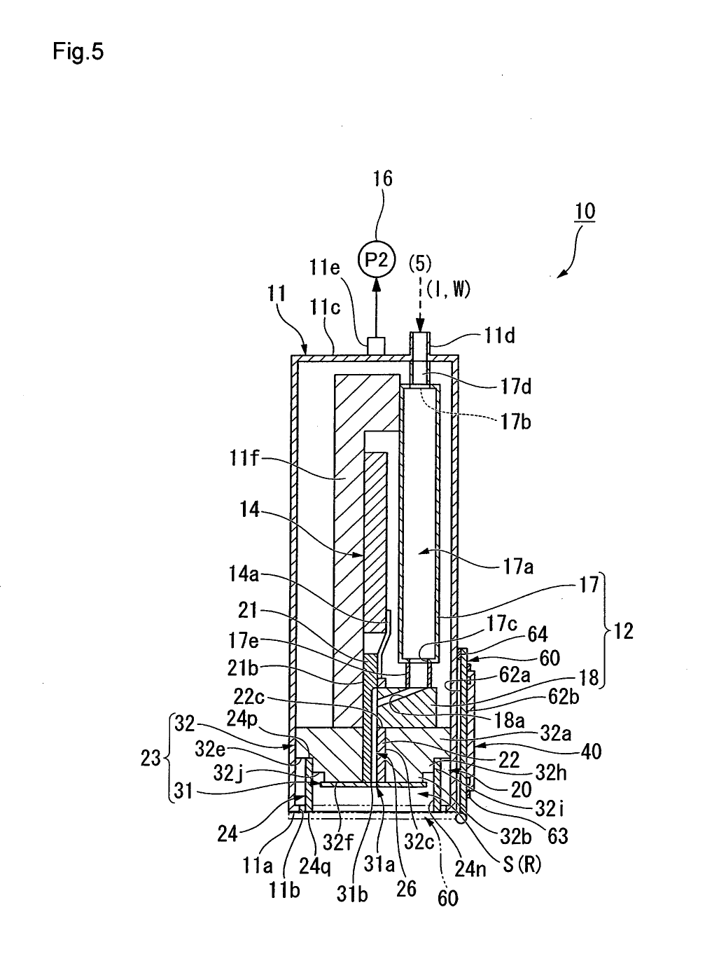

FIG. 3 is a front view of the ink jet head 10. FIG. 4 is a schematic structural view of the ink jet head 10 viewed from a right side. FIG. 5 is a sectional view taken along the line I-I of FIG. 4. It is to be noted that FIG. 3 and FIG. 5 illustrate the ink jet head 10 with an opening and closing mechanism 60 to be described later being in an open state, while FIG. 4 illustrates the ink jet head 10 with the opening and closing mechanism 60 being in a closed state.

As illustrated in FIG. 4, the ink jet head 10 includes a case 11, a liquid supply system 12, a head chip 20, a drive circuit board 14 (see FIG. 5), a suction flow path 15, and an atmosphere release flow path (atmosphere release portion) 33.

The case 11 is in the shape of a thin box with an exposure hole 11b formed in a front surface portion 11a thereof, and is fixed in the enclosure 6 with a thickness direction thereof being horizontal and with the exposure hole 11b oriented to the opening 6b. As illustrated in FIG. 4 and FIG. 5, through holes for communicating with internal space are formed in a back surface portion 11c of the case 11. More specifically, an atmosphere communication hole 11h is formed in an upper portion in a height direction, an ink injection hole 11d is formed in a substantially middle portion, and an ink suction hole 11e is formed in a lower portion. The case 11 includes in the internal space thereof a base plate 11f fixed to the case 11 so as to be upright, and houses structural items of the ink jet head 10.

The liquid supply system 12 communicates with the ink supply portion 5 via the ink injection hole 11d, and substantially formed of a damper 17 and an ink flow path substrate 18.

As illustrated in FIG. 5, the damper 17 is for the purpose of adjusting pressure fluctuations of the ink I, and includes a storing chamber 17a for storing the ink I. The damper 17 is fixed to the base plate 11f and includes an ink intake hole 17b connected to the ink injection hole 11d via a tube member 17d and an ink outflow hole 17c connected to the ink flow path substrate 18 via a tube member 17e.

The ink flow path substrate 18 is, as illustrated in FIG. 4, a member formed so as to be vertically long, and, as illustrated in FIG. 5, a member having a circulation path 18a formed therein, which communicates with the damper 17 and through which the ink I passes, and is attached to the head chip 20.

As illustrated in FIG. 5, the drive circuit board 14 includes a control circuit (not shown) and a flexible substrate 14a. The drive circuit board 14 applies voltage to a ceramic piezoelectric plate (actuator) 21 according to a print pattern with one end of the flexible substrate 14a being joined to plate-like electrodes 28 to be described later and the other end being joined to a control circuit (not shown) on the drive circuit board 14. The drive circuit board 14 is fixed to the base plate 11f.

(Head Chip)

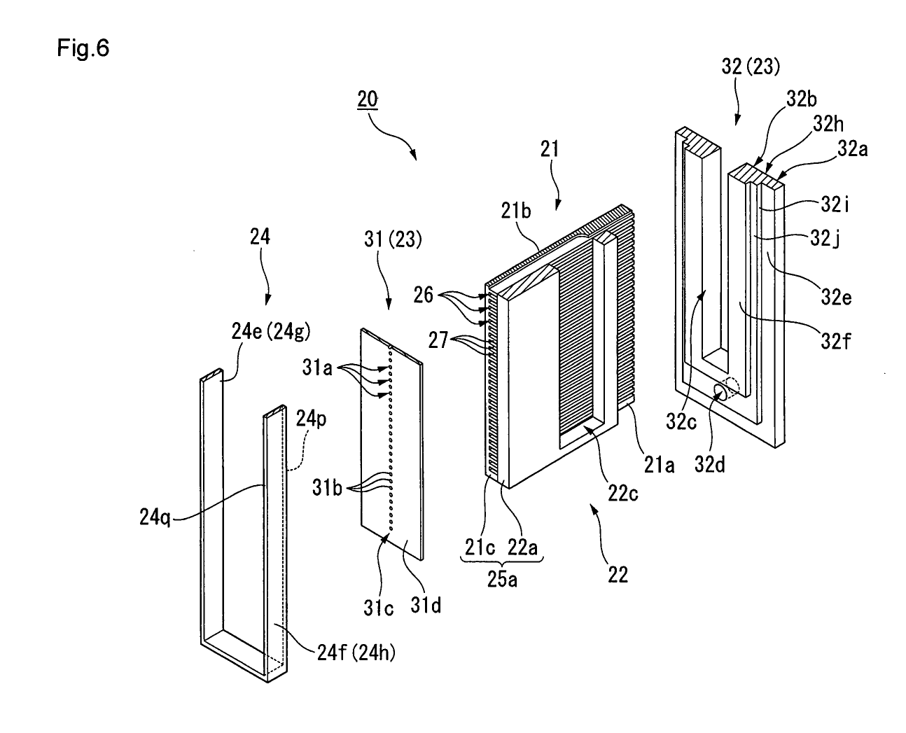

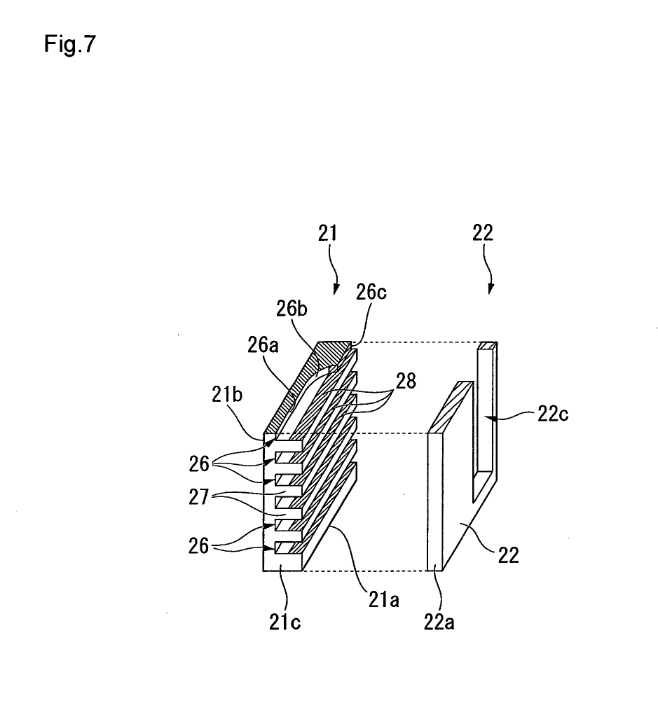

FIG. 6 is an exploded perspective view of the head chip 20. FIG. 7 is an exploded perspective view illustrating details of the ceramic piezoelectric plate 21 and an ink chamber plate 22. It is to be noted that, in FIG. 6, the opening and closing mechanism 60 and an absorber 40 to be described later are omitted.

As illustrated in FIG. 6, the head chip 20 includes the ceramic piezoelectric plate 21, the ink chamber plate 22, a nozzle body (jetting body) 23, and a wall portion 24.

The ceramic piezoelectric plate 21 is a substantially rectangular plate-like member formed of lead zirconate titanate (PZT) and, as illustrated in FIG. 6 and FIG. 7, has a plurality of long grooves (pressure generating chambers) 26 provided on one plate surface 21a of two plate surfaces 21a and 21b thereof so as to be stacked on top of one another, and the respective long grooves 26 are isolated from one another by side walls 27.

As illustrated in FIG. 6, the long grooves 26 are provided so as to extend in a direction of a short side of the ceramic piezoelectric plate 21, and the plurality of long grooves 26 are provided so as to be stacked on top of one another over the whole length in a direction of a long side of the ceramic piezoelectric plate 21. As illustrated in FIG. 7, each of the long grooves 26 is formed so that its section in a thickness direction of the piezoelectric actuators is rectangular. A bottom surface of each of the long grooves 26 includes a front flat surface 26a which extends from a front side surface 21c of the ceramic piezoelectric plate 21 to a substantially middle portion in the direction of the short side, a sloped surface 26b at which the depth of the groove gradually becomes smaller from an end of the front flat surface 26a toward a back side surface, and a back flat surface 26c which extends from an end of the sloped surface 26b toward the back side surface. It is to be noted that the respective long grooves 26 are formed with a disc-like dice cutter.

The plurality of side walls 27 are provided so as to be stacked on top of one another over the long side of the ceramic piezoelectric plate 21 for partitioning into the long grooves 26. The plate-like electrodes 28 for applying drive voltage are provided on the opening side of the long grooves 26 of wall surfaces of the side walls 27 (on the plate surface 21a side) so as to extend in the direction of the short side of the ceramic piezoelectric plate 21. The plate-like electrodes 28 are formed by publicly known oblique deposition. The above-mentioned flexible substrate 14a is joined to the plate-like electrodes 28.

As illustrated in FIG. 5, a portion of the plate surface 21b on the back side surface side of the ceramic piezoelectric plate 21 is fixed to an edge portion of the base plate 11f, and the long grooves 26 extend toward the exposure hole 11b.

Reference is made again to FIG. 6 and FIG. 7. The ink chamber plate 22 is, similarly to the ceramic piezoelectric plate 21, a substantially rectangular plate-like member. Compared with the size of the ceramic piezoelectric plate 21, the ink chamber plate 22 is formed so that its size in the direction of the long side is substantially the same as that of the ceramic piezoelectric plate 21 and its size in the direction of the short side is smaller than that of the ceramic piezoelectric plate 21. The ink chamber plate 22 includes an open hole 22c which passes through the thickness and which is formed over the long side of the ink chamber plate 22.

It is to be noted that, although the ink chamber plate 22 may be formed of a ceramic plate, a metal plate, or the like, taking into consideration deformation after being joined to the ceramic piezoelectric plate 21, a ceramic plate the coefficient of thermal expansion of which is similar thereto is used.

As illustrated in FIG. 6, the ink chamber plate 22 is joined to the ceramic piezoelectric plate 21 from the plate surface 21a side so that a front side surface 22a thereof and the front side surface 21c of the ceramic piezoelectric plate 21 are flush with each other and form an abutting surface 25a. In this joined state, the open hole 22c exposes the whole of the plurality of long grooves 26 of the ceramic piezoelectric plate 21, all the long grooves 26 are open to the outside, and the respective long grooves 26 are in a communicating state.

As illustrated in FIG. 5, the ink flow path substrate 18 is attached to the ink chamber plate 22 so as to cover the open hole 22c. The circulation path 18a in the ink flow path substrate 18 communicates with the respective long grooves 26.

As illustrated in FIG. 5, the nozzle body 23 is formed by sticking a nozzle plate 31 to a nozzle cap 32.

As illustrated in FIG. 6, the nozzle plate 31 is a thin-plate-like, strip-like member formed of polyimide or the like, and a plurality of nozzle holes 31a which pass through the thickness thereof line up to form a nozzle column 31c. More specifically, the nozzle holes 31a the number of which is the same as that of the long grooves 26 are formed in line at the middle in the direction of the short side of the nozzle plate 31 at the same intervals as those of the long grooves 26.

A water-repellent film (not shown) which is water-repellent for the purpose of preventing adhesion of ink and the like is applied to, of two plate surfaces of the nozzle plate 31, a plate surface (opening surface) 31d to which nozzle orifices (liquid nozzles) 31b for discharging the ink I is open, while the other plate surface is a surface to which the abutting surface 25a and the nozzle cap 32 are joined.

It is to be noted that the nozzle holes 31a are formed using an excimer laser.

The nozzle cap 32 is a member in the shape of a frame-plate-like member with an outer periphery of one of two frame surfaces being cut away, and is a member including a thin-plate-like outer frame portion 32a, a middle frame portion 32h which is thicker than the outer frame portion 32a, an inner frame portion 32b which is thicker than the middle frame portion 32h, a long hole 32c which passes through the thickness at the middle portion in the direction of the short side of the inner frame portion 32b and which extends in the direction of the long side, and a discharge hole 32d which passes through the thickness at an end portion of the middle frame portion 32h. In other words, the middle frame portion 32h and the inner frame portion 32b protrude in the thickness direction from an outer frame surface 32e of the outer frame portion 32a so as to be step-like so that the contour of a section in the thickness direction is like stairs in which the heights of the outer frame portion 32a, the middle frame portion 32h, and the inner frame portion 32b become larger in this order toward the long hole 32c.

The nozzle plate 31 is stuck to an inner frame surface 32f which extends in the same direction as the outer frame surface 32e so as to block the long hole 32c. The wall portion 24 is in abutting contact with a middle side surface 32i which extends from the outer frame surface 32e in a direction of the normal to the outer frame surface 32e and with the outer frame surface 32e.

The nozzle body 23 is housed in the internal space of the case 11 so that the discharge hole 32d of the nozzle cap 32 is located on a lower side (see FIG. 3), and is fixed to the case 11 and the base plate 11f (see FIG. 5).

In this state, a part of the ceramic piezoelectric plate 21 and a part of the ink chamber plate 22 are inserted in the long hole 32c and the nozzle plate 31 is in abutment with the abutting surface 25a. Further, the nozzle plate 31 is adhered to the inner frame surface 32f by an adhesive. Compared with the area of the inner frame surface 32f, the area of the nozzle plate 31 is formed so as to be larger, and the nozzle plate 31 is disposed so as to extend beyond the edges of the inner frame surface 32f to some extent.

In such a structure, when a predetermined amount of the ink I is supplied from the storing chamber 17a in the damper 17 to the ink flow path substrate 18, the supplied ink I is fed via the open hole 22c into the long grooves 26.

It is to be noted that a gap between the ink chamber plate 22 and the long grooves 26 on the back flat surface 26c side of the long grooves 26 (see FIG. 7) is sealed by a sealing material.

(Wall Portion)

As illustrated in FIG. 6, the wall portion 24 is a member substantially in the shape of a frame formed of stainless steel, and is fixed to the nozzle cap 32 with the middle frame portion 32h being fitted thereinto. As illustrated in FIG. 5, on an edge 24p (hereinafter referred to as back end portion 24p) side of the wall portion 24, the back end portion 24p is in abutting contact with the outer frame surface 32e and is fixed by an adhesive or the like. The other edge 24q (hereinafter referred to as front end portion 24q) side of the wall portion 24 extends from the back end portion 24p side in a direction substantially orthogonal to the nozzle plate 31, and the wall portion 24 surrounds the nozzle plate 31. In this state, the back end portion 24p side of an inner surface 24e of the wall portion 24 is in abutting contact with the middle side surface 32i. Further, the front end portion 24q side of the wall portion 24 is formed so as to reach the surface of the front surface portion 11a of the case 11, and a wall portion release opening 24n the area of which is substantially the same as that of a middle frame surface 32j of the middle frame portion 32h is formed. Therefore, the whole surface of the nozzle plate 31 described above is exposed from the wall portion release opening 24n (see FIG. 3). A region surrounded by the wall portion 24 forms inside space S (hereinafter referred to as space S) of the wall portion 24.

It is to be noted that a hydrophilic film 24g (see FIG. 6) is formed on the inner surface 24e of the wall portion 24 by titanium coating, while a water-repellent film 24h (see FIG. 6) is formed on an outer surface 24f on the back of the inner surface 24e and on the front end portion 24q by fluorine resin coating or Teflon (registered trademark) plating.

(Opening and Closing Mechanism)

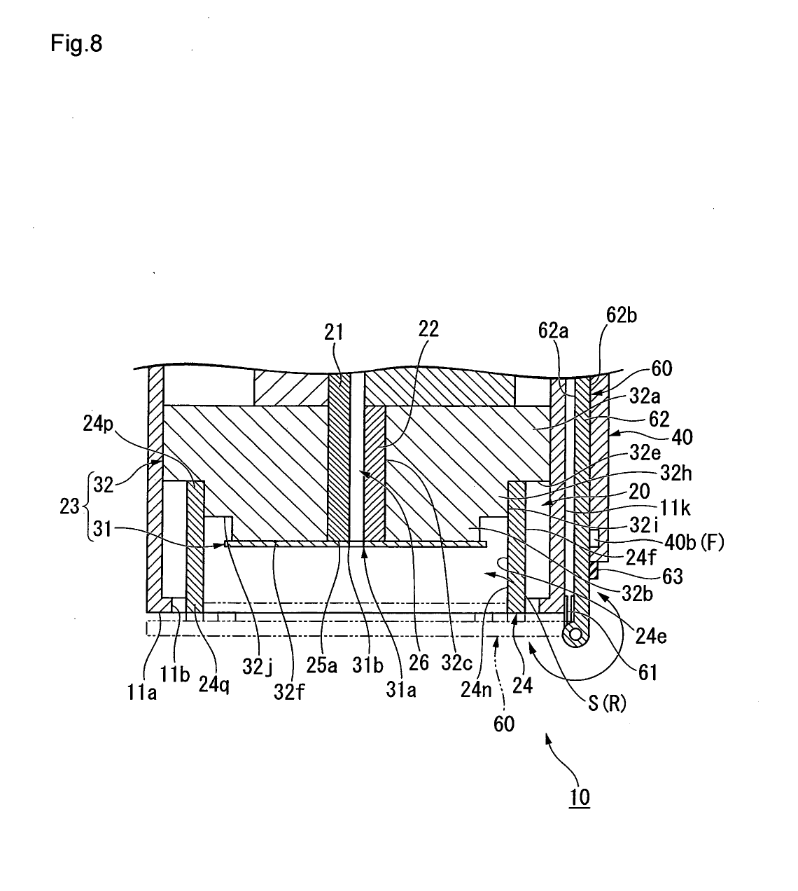

FIG. 8 is a sectional view of a principal part of the ink jet head and is an enlarged view corresponding to FIG. 5.

Here, as illustrated in FIG. 8, the opening and closing mechanism 60 is provided on the wall portion release opening 24n side, that is, on a side surface 11k of the case 11. The opening and closing mechanism 60 is supported by a hinge portion 61 provided on the side surface 11k of the case 11, and includes a door (lid member) 62 formed to be capable of opening and closing the wall portion release opening 24n in the wall portion 24 with the hinge portion 61 being the center of rotation, urging means (not shown) for urging the door 62 in a closing direction (in a direction of closing the wall portion release opening 24n), and a seal member 63 for sealing a gap between the door 62 in a state of closing the wall portion release opening 24n and the end surface on the front end portion 24q side of the wall portion 24.

The plurality of (for example, three) hinge portions 61 are arranged on the side surface 11k of the case 11 along the direction of the long side of the case 11, with one end thereof being coupled to the side surface 11k of the case 11 and the other end thereof being coupled to the door 62.

The door 62 is a flat plate in the shape of a rectangle seen in plan view formed of a metal or the like, and the area of the door 62 is larger than the area of the opening of the wall portion release opening 24n. The other ends of the hinge portions 61 are coupled to a front surface 62a of the door 62 (a surface of the door 62 located outside in the closed state), and the door 62 is formed to rotate by about 270 degrees (see an arrow of FIG. 8) with the hinge portions 61 being the center of rotation. The urging means such as a torsion spring for urging the door 62 in the closing direction is disposed between the hinge portions 61 and the door 62. Further, the above-mentioned water-repellent film (not shown) is formed on a back surface 62b of the door 62 (a surface of the door 62 located inside in the closed state) by fluorine resin coating or Teflon (registered trademark) plating.

The seal member 63 is formed of an elastic material such as rubber, and is formed over the whole outer periphery of the back surface 62b of the door 62 (see FIG. 3). The seal member 63 is disposed so as to be, in the closed state of the door 62, in abutting contact with the whole periphery of the front end portion 24q of the wall portion 24 to surround the wall portion release opening 24n. Further, a magnet 64 (see FIG. 5) which may attract the door 62 is disposed on the side surface 11k of the case 11. The magnet 64 is for the purpose of, in the open state of the door 62, fixing the door 62 in the open state by attracting the front surface 62a of the door 62, and is disposed in the direction of the long side of the case 11.

More specifically, in the open state, the door 62 is formed to expose the nozzle holes 31a and the nozzle plate 31 to the outside by opening the wall portion release opening 24n, while, in the closed state, the door 62 is formed to close the wall portion release opening 24n so that the space S between the wall portion 24 and the nozzle plate 31 becomes closed space.

(Absorber)

As illustrated in FIG. 3, FIG. 4, and FIG. 8, the absorber 40 is stuck to, of the back surface 62b of the door 62, the whole of a surface which is exposed to the space S in the closed state of the opening and closing mechanism 60, in other words, to an inner surface surrounded by the seal member 63. More specifically, the absorber 40 is a member in the shape of a rectangle seen in plan view the size of which is substantially the same as that of a section of the opening in the direction of the opening of the wall portion release opening 24n in the wall portion 24, and is opposed to the nozzle plate 31 with a gap therebetween when the opening and closing mechanism 60 is in the closed state.

As illustrated in FIG. 4, the absorber 40 includes a groove portion 40b formed in a contact surface 40a with the back surface 62b of the door 62 and a circular hole 40c which passes through a surface opposite to the contact surface 40a and the groove portion 40b.

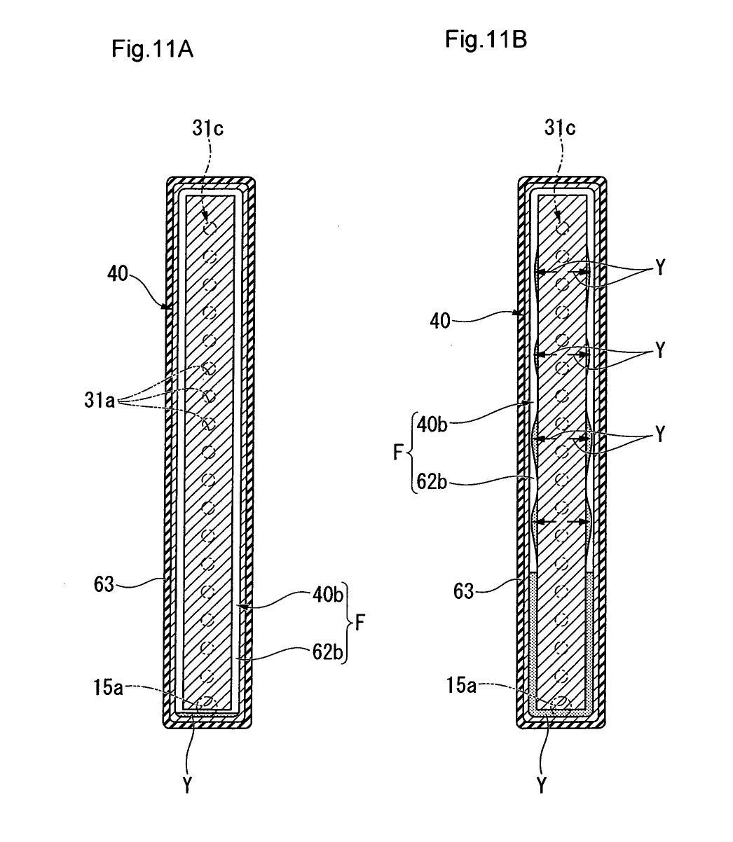

The groove portion 40b is formed so as to surround the nozzle column 31c viewed from the direction of the openings of the nozzle holes 31a in the closed state of the opening and closing mechanism 60 (see FIG. 3 and FIG. 11). In such a structure, when the contact surface 40a is brought into intimate contact with the back surface 62b of the door 62, the groove portion 40b forms a tubular drainage flow path F together with the back surface 62b.

As illustrated in FIG. 3 and FIG. 4, the size of a section of the circular hole 40c is substantially the same as that of a section of a tube which forms the suction flow path 15 to be described later, and the circular hole 40c is formed in a lower portion of the absorber 40.

As the material of the absorber 40, a porous film of such as polyvinyl alcohol (PVA) (for example, Belleater A series of Kanebo, Ltd.) or high-density polyethylene powder (for example, one manufactured by Asahi Kasei Corporation (Sunfine)) is preferably used. Further, the absorber 40 may be stuck using an adhesive. In this case, for example, it is preferred that the adhesion be made by applying spots of an adhesive of an epoxy resin or the like which has high viscosity.

As illustrated in FIG. 4, in the suction flow path 15, one end of the tube to be a suction port 15a is inserted in the discharge hole 32d and is fixed while the other end is connected to the ink suction hole 11e.

The suction flow path 15 protrudes from the nozzle cap 32 so that, in the closed state of the opening and closing mechanism 60, the one end of the tube to be the suction port 15a is inserted in the circular hole 40c, and the suction port 15a is open to the drainage flow path F in the closed state.

Further, the suction pump 16 mounted outside the ink jet head 10 is connected to the ink suction hole 11e via a tube. In operation, the suction pump 16 sucks air and the ink I in the space S to cause the space S to become a negative pressure chamber R. It is to be noted that the suction pump 16 stores the sucked ink I in a waste liquid tank E (see FIG. 2).

The suction pump 16 may be mounted on the ink jet head 10, or, as in this embodiment, may be separate and included on the ink jet recording apparatus side. In this embodiment, because the suction pump 16 is provided on the apparatus side, it is not necessary to attach the suction pump 16 on the ink jet head 10 side, which enables simplification of the structure of the ink jet head 10 and miniaturization of the ink jet head 10.

As illustrated in FIG. 3 and FIG. 4, the atmosphere release flow path 33 is provided in an upper portion of the middle frame portion 32h (on the side opposite to the discharge hole 32d), with one end thereof being inserted in and fixed to an open hole 32n which passes through the thickness of the middle frame portion 32h and the other end thereof being connected to the above-mentioned atmosphere communication hole 11h in the case 11. More specifically, the atmosphere release flow path 33 is formed above the uppermost nozzle hole 31a of the nozzle column 31c, with the one end thereof forming an atmosphere release opening 33a exposed to the space S of the wall portion 24. This enables the space S of the wall portion 24 to communicate with the outside via the atmosphere release flow path 33 and the atmosphere communication hole 11h in the case 11.

Reference is made again to FIG. 2. The ink supply portion 5 includes an ink tank 51 in which the ink I is stored, a cleaning liquid tank 52 in which the cleaning liquid W is stored, and a changeover valve 53 which may switch between two flow paths.

The ink tank 51 and the cleaning liquid tank 52 are connected to the ink injection hole 11d via a supply tube 57a, the changeover valve 53, and a supply tube 57c, and via a supply tube 57b, the changeover valve 53, and the supply tube 57c, respectively. More specifically, the supply tubes 57a and 57b as inflow tubes and the supply tube 57c as an outflow tube are connected to the changeover valve 53.

Further, a tube 54a is connected to the atmosphere communication hole 11h in the case 11, and an atmosphere release valve 55 is connected via the tube 54a. The tube 54a as an outflow tube and a tube 54b as an inflow tube which communicates with the tube 54a via the atmosphere release valve 55 are connected to the atmosphere release valve 55. In the open state, the atmosphere release valve 55 enables the space S to communicate with the outside via the tubes 54a and 54b, the atmosphere communication hole 11h, and the atmosphere release opening 33a, while, in the closed state, the atmosphere release valve 55 interrupts the communication between the outside and the space S. More specifically, communication of the space S with the outside and interruption of the communication are able to be switched by the above-mentioned atmosphere communication hole 11h in the case 11, atmosphere release flow path 33 in the nozzle cap 32, and atmosphere release valve 55.

Next, operation of the ink jet recording apparatus 1 structured as described above is described. In the following, a case in which printing is carried out on the box D after the ink jet head 10 is initially filled with the ink I is described, and further, a case in which the ink jet head 10 is cleaned is described.

(Initial Filling of Ink)

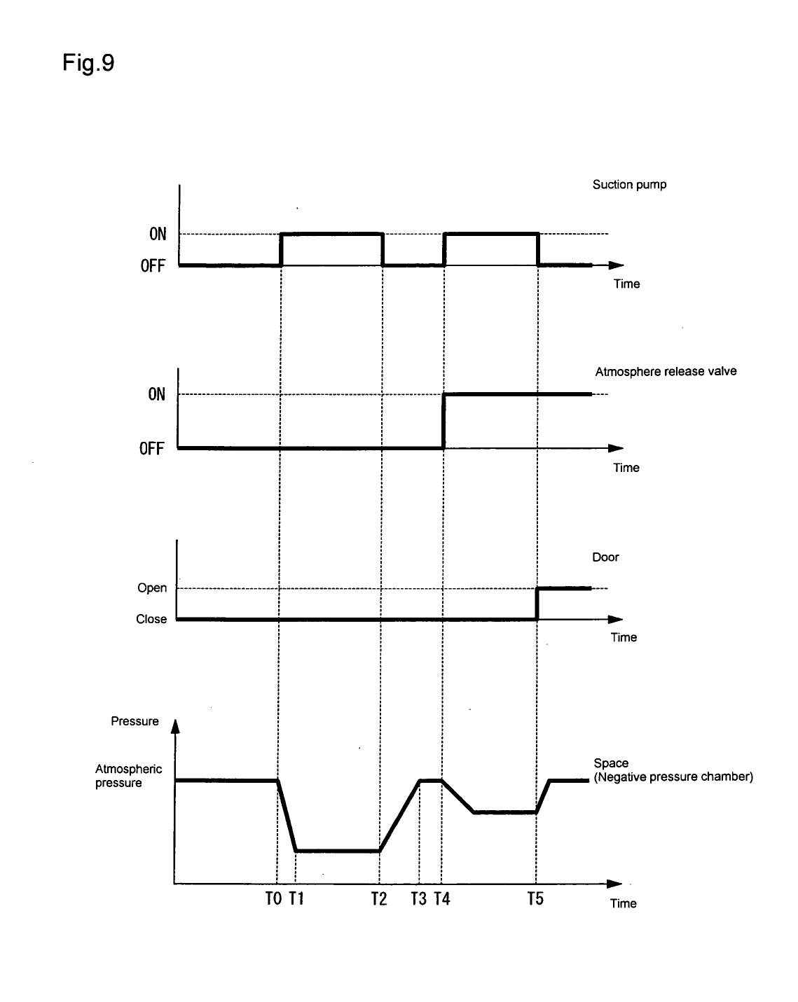

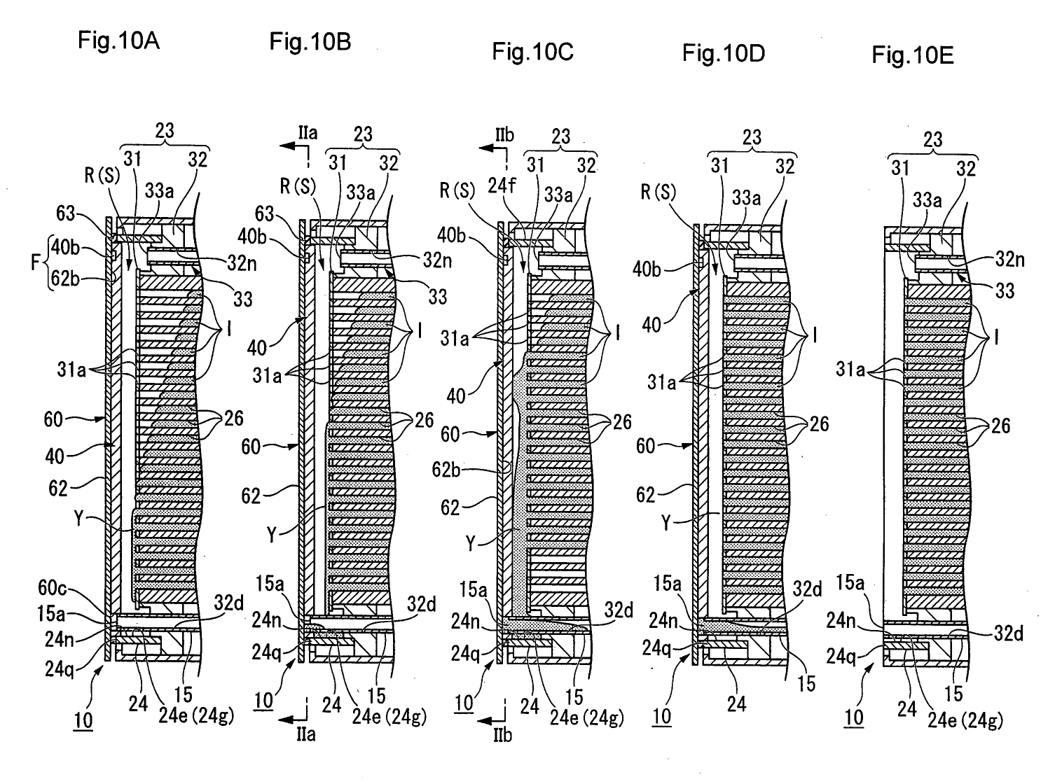

FIG. 9 shows graphs of a relationship among operation timing of the suction pump 16, operation timing of the atmosphere release valve 55, operation timing of the opening and closing mechanism 60 (door 62), and the space S (negative pressure chamber R). FIG. 10 are enlarged sectional views of a principal part of the head chip 20 illustrating operation of initial filling. FIG. 11 are sectional views taken along the line IIa-IIa of FIG. 10B and IIb-IIb of FIG. 10C.

First, as illustrated in FIG. 4 and FIG. 9, the suction pump 16 is operated and the suction pump 16 sucks air in the space S from the suction port 15a via the suction flow path 15 (at time T0 of FIG. 9). Here, the atmosphere release valve 55 and the door 62 of the opening and closing mechanism 60 are closed so that the communication between the closed space and the outside is interrupted. Then, because air in the space S is sucked from the suction port 15a via the absorber 40, the space S is depressurized. Here, in the drainage flow path F to which the suction port 15a is open, the extent of the negative pressure is higher than that in other places in the space S.

After a predetermined time passes, at T1, the space S becomes the negative pressure chamber R in which the pressure becomes negative enough compared with atmospheric pressure.

When the space S becomes the negative pressure chamber R, suction filling of the ink I from the ink tank 51 of the ink supply portion 5 is carried out. More specifically, as illustrated in FIG. 2, by communicating the supply tube 57a with the supply tube 57c by the changeover valve 53, the ink I to be filled from the ink tank 51 is injected from the ink tank 51 via the supply tubes 57a and 57c into the ink injection hole 11d of the ink jet head 10.

As illustrated in FIG. 4 and FIG. 5, the ink I injected into the ink injection hole 11d flows in the storing chamber 17a via the ink intake hole 17b in the damper 17, and then, flows out to the circulation path 18a in the ink flow path substrate 18 via the ink outflow hole 17c. Then, the ink I which flows in the circulation path 18a flows in the respective long grooves 26 via the open hole 22c.

The ink I which flows in the respective long grooves 26 flows to the nozzle hole 31a side, and, after reaching the nozzle holes 31a, as illustrated in FIG. 10A, flows out from the nozzle holes 31a as excess ink Y. At the beginning of the outflow of the excess ink Y, because the amount is small, the excess ink Y flows downward on the nozzle plate 31.

The excess ink Y which reaches a lower portion of the negative pressure chamber R is once absorbed by the absorber 40. Then, as illustrated in FIG. 10B and FIG. 11A, the excess ink Y flows out to the drainage flow path F the extent of the negative pressure of which is higher than that in other places in the negative pressure chamber R, sucked from the suction port 15a, passes through the suction flow path 15, and is discharged to the waste liquid tank E.

In this process, because the atmosphere release valve 55 and the door 62 are closed, the negative pressure chamber R forms closed space, and air is continuously sucked from the negative pressure chamber R by the suction pump 16, and hence the excess ink Y does not flow out of the wall portion release opening 24n to the outside and is not stored in the negative pressure chamber R.

When the amount of the excess ink Y which flows out becomes large, as illustrated in FIG. 10C, the excess ink Y scatters forward from the nozzle orifices 31b or, in the process of flowing downward on the nozzle plate 31, comes into contact with the absorber 40 (see FIG. 10C). Much of such excess ink Y is absorbed by a portion of the absorber 40 which is in proximity to a region opposed to the nozzle holes 31a, and after that, as illustrated in FIG. 11B, flows out to the drainage flow path F the extent of the negative pressure of which is higher than that in other places in the negative pressure chamber R, flows downward in the drainage flow path F, and then, is promptly discharged from the suction port 15a. Here, even if the excess ink Y is locally absorbed by a part of the absorber 40, the excess ink Y which reaches the vicinity of the back surface 62b at that place is repelled by the back surface 62b and spreads in a direction of the surface, and thus, it is easy for the excess ink Y to flow out to the drainage flow path F.

In this way, the excess ink Y is continually discharged to the waste liquid tank E.

After the long grooves 26 is filled to some extent with the ink I, the suction pump 16 is once stopped (at T2 of FIG. 9). Then, the pressure environment in the negative pressure chamber R is still kept in the negative pressure state. Because the negative pressure state is kept, as illustrated in FIG. 10C, the excess ink Y overflows from, among the nozzle holes 31a, a nozzle hole 31a with regard to which filling of the ink I is completed, while the ink I is filled to a tip of a nozzle hole 31a with regard to which filling of the ink I is not completed as yet. Because the ink I is filled using the pressure in the negative pressure chamber R (negative pressure), as the ink I is filled, the pressure in the negative pressure chamber R is used and the negative pressure is gradually dissipated (T2 to T3 of FIG. 9). With this mechanism, the pressure environment in the negative pressure chamber R gradually approaches the atmospheric pressure, and reaches equilibrium when the pressure is substantially the same as the atmospheric pressure.

In this way, the ink I is filled into the whole of the long grooves 26 and the nozzle holes 31a. After a predetermined time passes, at T3, the pressure in the negative pressure chamber R recovers and again becomes substantially the same as the atmospheric pressure.

Here, the excess ink Y which overflows from the nozzle holes 31a accumulates in the space S. Therefore, after the inside of the space S is under atmospheric pressure (at T4 of FIG. 9), the atmosphere release valve 55 is released and the suction pump 16 is again operated. When air in the space S is sucked by the suction pump 16 with the atmosphere release valve 55 being released, air passes from the outside via the atmosphere release valve 55, the tubes 54a and 54b, and the atmosphere communication hole 11h toward the space S. Therefore, the ink I in the ink tank 51 (see FIG. 2) is not sucked, and the pressure in the negative pressure chamber R recovers. Air which flows from the outside in the space S is discharged via the absorber 40 and the suction port 15a to the waste liquid tank E. Here, as illustrated in FIG. 10D, the excess ink Y which accumulates in the absorber 40 flows out to the groove portion 40b and is discharged from the suction port 15a to the waste liquid tank E (see FIG. 11B), and thus, the ability of the absorber 40 to absorb the ink is restored.

After that, as illustrated in FIG. 9, after a predetermined time passes, at T5, the suction pump 16 is stopped to end suction filling of the ink I. In association with the stop of the suction pump 16, the excess ink Y no longer flows out of the nozzle holes 31a, and all the excess ink Y which remains in the negative pressure chamber R is absorbed by the absorber 40. After the filling of the ink I is completed, as illustrated in FIG. 10E, the nozzle holes 31a and the long grooves 26 are filled with the ink I.

By, simultaneously with this, causing the door 62 of the opening and closing mechanism 60 to be in the open state and opening the wall portion release opening 24n, printing becomes possible. Here, in the space S, the excess ink Y does not exist, or, even if the excess ink Y exists, because the excess ink Y is absorbed by the absorber 40, the excess ink Y does not droop down to the outside. In this way, initial filling of the ink I is completed.

(In Printing)

Next, operation when printing is carried out on the box D is described. First, setting of the ink supply portion 5 is described. As illustrated in FIG. 2, the ink I is injected via the supply tubes 57a and 57c into the ink injection hole 11d of the ink jet head 10 by causing the supply tube 57a and the supply tube 57c to communicate with each other by the changeover valve 53.

The belt conveyor 2 is driven with the ink supply portion 5 being set as described above (see FIG. 1), the box D is transferred in one direction, and, when the transferred box D passes in front of the enclosures 6, that is, passes in front of the nozzle plates 31 (nozzle holes 31a), the ink discharging portions 3 discharge ink droplets toward the box D.

More specifically, based on print data which is input from an outside personal computer, the drive circuit board 14 selectively applies voltage to predetermined plate-like electrodes 28 correspondingly to the print data. This reduces the capacities of the long grooves 26 corresponding to the plate-like electrodes 28, and the ink I filled into the long grooves 26 is discharged from the nozzle orifices 31b toward the box D.

When the ink I is discharged, the long grooves 26 are under negative pressure, and thus, the ink I is filled into the long grooves 26 via the above-mentioned supply tubes 57a and 57c.

In this way, the ceramic piezoelectric plate 21 of the ink jet head 10 is driven according to the image data, and ink droplets are discharged from the nozzle holes 31a to land on the box D. In this way, by continually discharging ink droplets from the ink jet head 10 while the box D is moved, an image (text) is printed on desired locations of the box D.

(In Cleaning)

Next, operation when the ink jet head 10 is cleaned is described. First, setting of the ink supply portion 5 is described. As illustrated in FIG. 2, the supply tube 57b and the supply tube 57c are caused to communicate with each other by the changeover valve 53. By operating the suction pump 16 with this state being kept, the cleaning liquid W is injected from the cleaning liquid tank 52 via the supply tubes 57b and 57c into the ink injection hole 11d of the ink jet head 10. It is to be noted that, in this state, the atmosphere release valve 55 and the door 62 of the opening and closing mechanism 60 are closed.

Similarly to the case of the above-mentioned initial filling, the cleaning liquid W is caused to flow out of the nozzle holes 31a via the long grooves 26 and the like, and the cleaning liquid W which flows out is sucked from the suction port 15a.

It is to be noted that, when the ink jet recording apparatus 1 is not used for a long time, the ink I which is filled into the long grooves 26 is dried and hardened. In this case, similarly to the case of the cleaning, by filling the ink jet head 10 with the cleaning liquid W, the ink jet recording apparatus 1 may be stored for a long time.

As described above, in this embodiment, the structure having the opening and closing mechanism 60 for forming the space S (closed space) between the wall portion 24 and the nozzle plate 31 and the atmosphere release flow path 33 for communicating the space S with the outside is provided.

According to the structure, by closing the wall portion release opening 24n in the wall portion 24 with the opening and closing mechanism 60, the ink I may be filled and the excess ink Y which flows out of the nozzle holes 31a may be collected only through suction with the suction pump 16 via the suction flow path 15.

More specifically, with the wall portion release opening 24n being closed, by sucking with the suction pump 16 air in the space S between the wall portion 24 and the nozzle plate 31, the space S is depressurized to form the negative pressure chamber R. This enables suction filling from the ink tank 51 via the liquid supply system 12 into the long grooves 26 and the nozzle holes 31a. Further, by closing the wall portion release opening 24n, the excess ink Y which flows out of the nozzle holes 31a in filling the ink I may be prevented from flowing out of the wall portion release opening 24n. By, after the ink I is filled, sucking air in the space S with the suction pump 16 via the suction flow path 15 with the atmosphere release flow path 33 (atmosphere release valve 55) being released, air passes via the atmosphere release flow path 33 from the outside toward the space S, and thus, ink in the ink tank 51 is not sucked and the pressure in the space S recovers. After that, the air which flows from the outside into the space S is discharged to the outside via the suction flow path 15. Here, the excess ink Y which flows out of the nozzle holes 31a and accumulates in the space S is, together with the air which passes through the space S, discharged to the waste liquid tank E.

Further, because the absorber 40 is provided on the back surface 62b of the door 62, the excess ink Y which scatters during suction filling of the ink I and the excess ink Y which is not completely sucked with the suction pump 16 are absorbed by the absorber 40. This may suppress flowing out of the excess ink Y to the outside when the door 62 is opened and closed. Therefore, compared with a case in which the absorber 40 is not provided on the back surface 62b of the door 62, the ability to collect the excess ink Y may be further improved, and contamination with the excess ink Y may be prevented more reliably.

Therefore, contamination with the excess ink Y may be prevented with a simple structure and initial filling of the ink jet recording apparatus 1 may be achieved without providing a complicated service station as in a conventional case. Accordingly, discharge of the ink I after the ink is filled may also be stabilized. Further, because the excess ink Y may be collected in the space S which is closed space, the ability to collect the excess ink Y may be improved, and still, space used for collecting the excess ink Y may be extremely small to improve the space factor of the ink jet head 10. This may improve the flexibility in designing the ink jet recording apparatus 1.

Further, by providing the atmosphere release flow path 33 above and providing the suction port 15a below, air passes from above to below (toward the suction port 15a) in the space S, and thus, the excess ink Y in the space S may be sucked reliably. Because the excess ink Y which flows out of the nozzle holes 31a droops down in the direction of gravity from the nozzle holes 31a, by providing the atmosphere release flow path 33 (atmosphere release opening 33a) above the nozzle column 31c, even if the atmosphere release opening 33a is released when the excess ink Y accumulates in the space S, the excess ink Y is prevented from flowing out of the atmosphere release flow path 33, and still, the space S and the outside may communicate with each other.

Further, by rotating the door 62 via the hinge portions 61, opening and closing operation of the door 62 may be carried out smoothly. Further, by depressurizing the space S with the wall portion release opening 24n being closed, the space S may reliably be the negative pressure chamber R, and the ability to collect the excess ink Y may be improved. Further, by urging the door 62 in the closing direction, closing operation of the door 62 may be carried out smoothly, and, when the door 62 is in the closed state, the door 62 is urged toward the wall portion 24. Therefore, the intimate contact between the wall portion 24 and the door 62 may be secured. Further, by disposing the seal member 63 on the back surface 62b of the door 62, the intimate contact between the door 62 and the front end portion 24q of the wall portion 24 may be improved.

Therefore, the excess ink Y may reliably be prevented from flowing out of the wall portion release opening 24n. This enables prevention of leakage of air from the wall portion release opening 24n and the space S may reliably be the negative pressure chamber R, and thus, compared with a case in which the suction is carried out with the wall portion release opening 24n being opened, the ability to collect the excess ink Y may be improved, and at the same time, initial filling may be carried out promptly.

Further, because the absorber 40 is provided on the whole of the surface which is exposed to the space S of the back surface 62b of the door 62 in the closed state of the opening and closing mechanism 60, in particular, during suction filling of the ink I, the whole excess ink Y which scatters toward the nozzle body 23 is absorbed by the absorber 40. This may suppress more effectively an outflow to the outside of the excess ink Y when the door 62 is opened and closed. Therefore, the ability to collect the excess ink Y may be further improved, and contamination with the excess ink Y may be prevented more reliably.

Further, because the suction port 15a is open to the groove portion 40b which forms the drainage flow path F, the extent of the negative pressure in the space S (negative pressure chamber R) is higher than that in other places in the drainage flow path F. This causes the excess ink Y absorbed by the absorber 40 to, after flowing out to the drainage flow path F, flow through the drainage flow path F toward the suction port 15a to be promptly discharged to the waste liquid tank E.

Because the ability of the absorber 40 to absorb the ink may be promptly restored, the ability to collect the excess ink Y may be further improved, and contamination with the excess ink Y may be prevented more reliably.

Further, because the drainage flow path F is formed so as to surround the nozzle column 31c and so as to be ring-shaped, the excess ink Y of the absorber 40 is caused to flow out to the drainage flow path F from all directions on the plane to be discharged to the waste liquid tank E. This may restore the ability of the absorber 40 to absorb the ink efficiently over a wide range.

Further, because the ink supply portion 5 is formed to be able to switchedly supply the ink I and the cleaning liquid W and the ink I and the cleaning liquid W are supplied to the liquid supply system 12, the labor of cleaning the ink jet head 10 may be reduced and the ink jet head 10 may be cleaned efficiently.

### Modified Examples of First Embodiment

Next, modified examples of this first embodiment are described. It is to be noted that like numerals and symbols are used to designate like or identical members in the ink jet head 10, and description thereof is omitted.

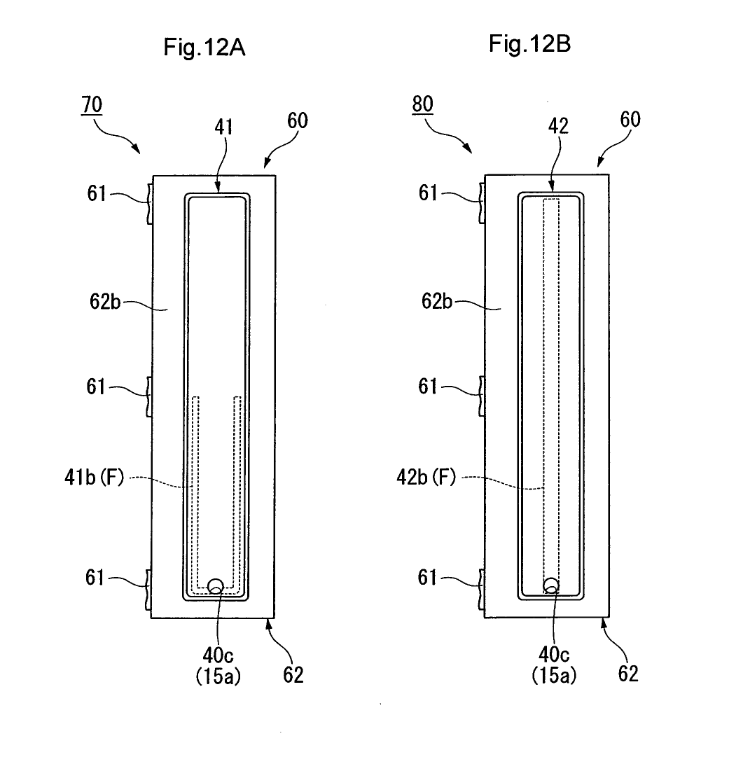

FIG. 12 illustrate modified examples of the ink jet head 10. FIG. 12A illustrates a principal part of an ink jet head 70 and FIG. 12B illustrates a principal part of an ink jet head 80. Those ink jet heads 70 and 80 are different from the ink jet head 10 in the shape of a drainage groove portion of the absorber.

As illustrated in FIG. 12A, in the ink jet head 70, a groove portion 41b is formed in an absorber 41. The groove portion 41b is formed so as to surround the nozzle column 31c and so as to be U-shaped viewed from the direction of the openings of the nozzle holes 31a in the closed state of the opening and closing mechanism 60.

According to the structure, because the drainage flow path F is formed so as to surround the nozzle column 31c and so as to be U-shaped, in the initial filling of the ink I, the excess ink Y which droops down from a portion of the absorber 41 which is opposed to the nozzle orifices 31b and which is easy to absorb the excess ink Y may be caused to flow out to the drainage flow path F to be discharged to the waste liquid tank E. This may efficiently restore the ability of the absorber 41 to absorb the ink.

As illustrated in FIG. 12B, in the ink jet head 80, a groove portion 42b is formed in an absorber 42. The groove portion 42b is linearly formed so as to overlap the nozzle column 31c viewed from the direction of the openings of the nozzle holes 31a in the closed state of the opening and closing mechanism 60.

According to the structure, because the drainage flow path F is linearly formed so as to overlie the nozzle column 31c, in the initial filling of the ink I, ink at a portion which is opposed to the nozzle orifices 31b and which is easy to absorb the excess ink Y is intensively caused to flow out to the drainage flow path F to be promptly discharged to the waste liquid tank E. More specifically, because the groove portion 42b is formed adjacent to the above-mentioned portion, the absorbed excess ink Y may be caused to directly flow out to the drainage flow path F to be promptly discharged to the outside. This may promptly restore the ability of the absorber 42 to absorb the ink.

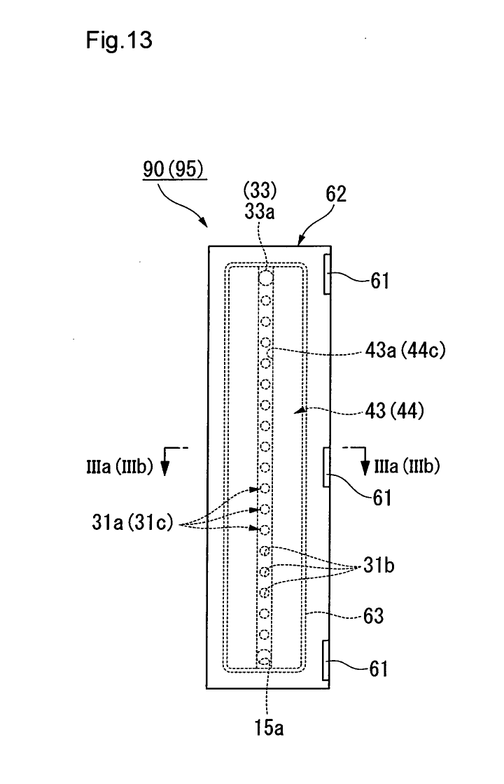

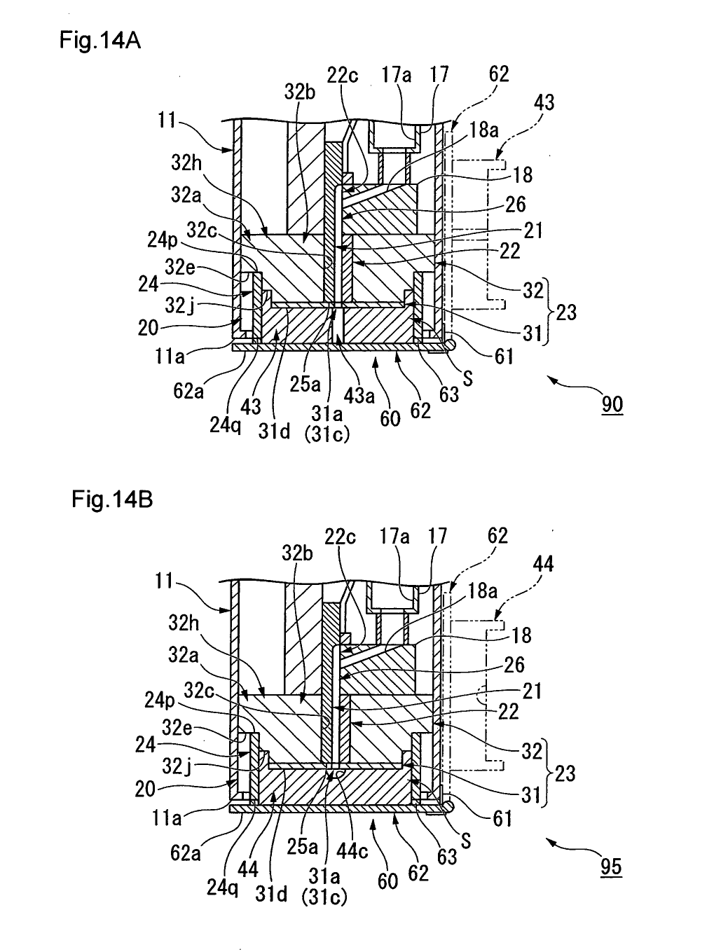

FIG. 13 illustrates other modified examples of the ink jet head 10 and is a front view of ink jet heads 90 and 95. FIG. 14 are enlarged sectional views of the ink jet heads 90 and 95 (a sectional view taken along the line IIIc-IIIa of FIG. 13 and a sectional view taken along the line IIIb-IIIb of FIG. 13).

Those ink jet heads 90 and 95 are different from the ink jet head 10 in that, in the closed state of the opening and closing mechanism 60, the absorber is disposed over the whole space S with no gap being provided between the absorber and the nozzle body 23.

As illustrated in FIG. 13 and FIG. 14A, in the ink jet head 90, an absorber 43 formed of the same material as that of the absorber 40 is formed to be disposed over the whole space S in the closed state of the opening and closing mechanism 60. A slit communicating portion (communicating portion) 43a which passes through the absorber 43 in the same direction as the direction of the openings of the nozzle holes 31a and extends in the direction of the long side of the absorber 43 is formed in the absorber 43.

The slit communicating portion 43a is formed so as to overlap the nozzle column 31c viewed from the direction of the openings of the nozzle holes 31a in the closed state of the opening and closing mechanism 60, and the slit communicating portion 43a and the atmosphere release flow path 33 are formed to communicate with each other.

According to the structure, because the absorber 43 is disposed so as to fill the whole space between the door 62 and the nozzle body 23, the absorber 43 absorbs a large amount of the excess ink Y. This may extremely make larger the amount of ink absorbed by the absorber 43, and the ability to collect the excess ink Y may be further improved and contamination with the excess ink Y may be prevented more reliably.

Further, because the slit communicating portion 43a is formed at a place in the absorber 43 which is opposed to the nozzle column 31c, the vicinity of the nozzle holes 31a in the plate surface 31d of the nozzle plate 31 and the absorber 43 are not brought into contact with each other. This prevents the excess ink Y absorbed by the absorber 43 from flowing back to the nozzle holes 31a and prevents the nozzle orifices 31b from being damaged, and discharge of the ink I after the ink is filled may be stabilized.

Further, the shape of the surface of the liquid (meniscus) in the nozzle orifices 31b after the ink I is filled may be formed with stability, and discharge of the ink I after the ink I is filled may be stabilized.

Further, because the excess ink Y may droop down in the slit communicating portion 43a, the excess ink Y may be promptly discharged to the waste liquid tank E.

As illustrated in FIG. 13 and FIG. 14B, in the ink jet head 95, an absorber 44 formed of the same material as that of the absorber 40 is formed to be disposed over the whole space S in the closed state of the opening and closing mechanism 60. A recessed communicating portion 44c which is recessed toward the inside of the absorber 44 so as to be substantially half-round along the direction of the long side of the absorber 44 is formed in a surface of the absorber 44 which is opposed to the nozzle plate 31.

The recessed communicating portion 44c is linearly formed so as to overlap the nozzle column 31c viewed from the direction of the openings of the nozzle holes 31a in the closed state of the opening and closing mechanism 60, and the recessed communicating portion 44c and the atmosphere release opening 33a are formed to communicate with each other.

According to the structure, also, effects similar to those of the above-mentioned ink jet head 90 may be obtained, and further, the volume of the absorber may be larger than that of the absorber 43 in the ink jet head 90, and thus, the amount of the ink I which is absorbed may be larger.

### Second Embodiment

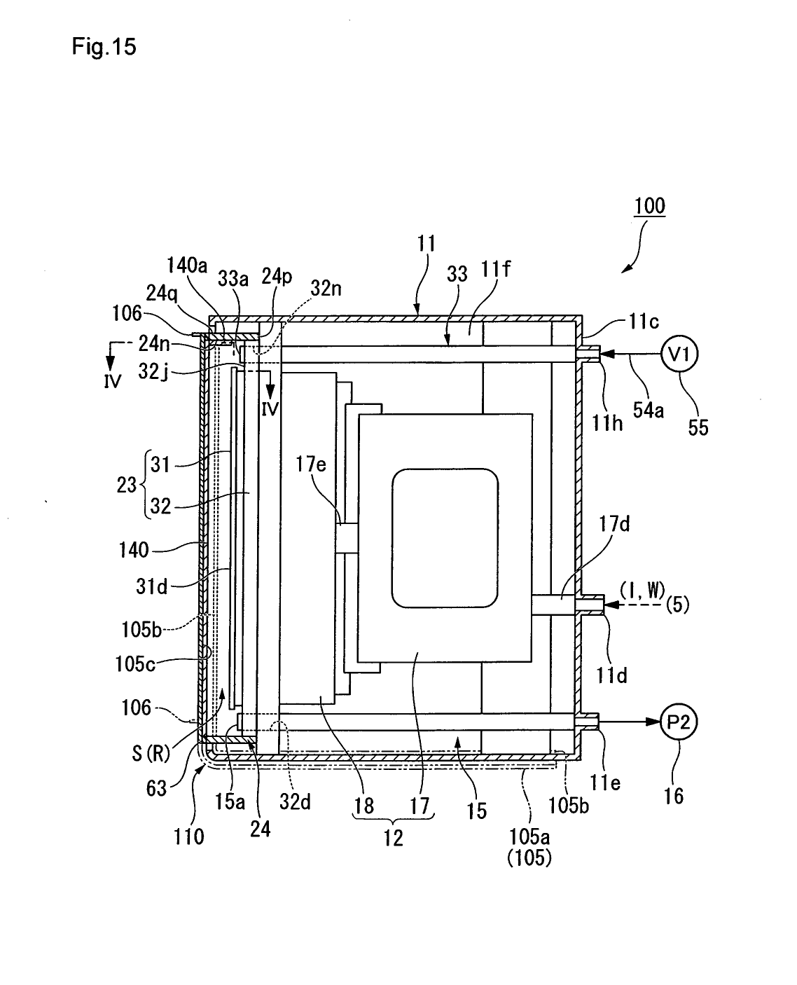

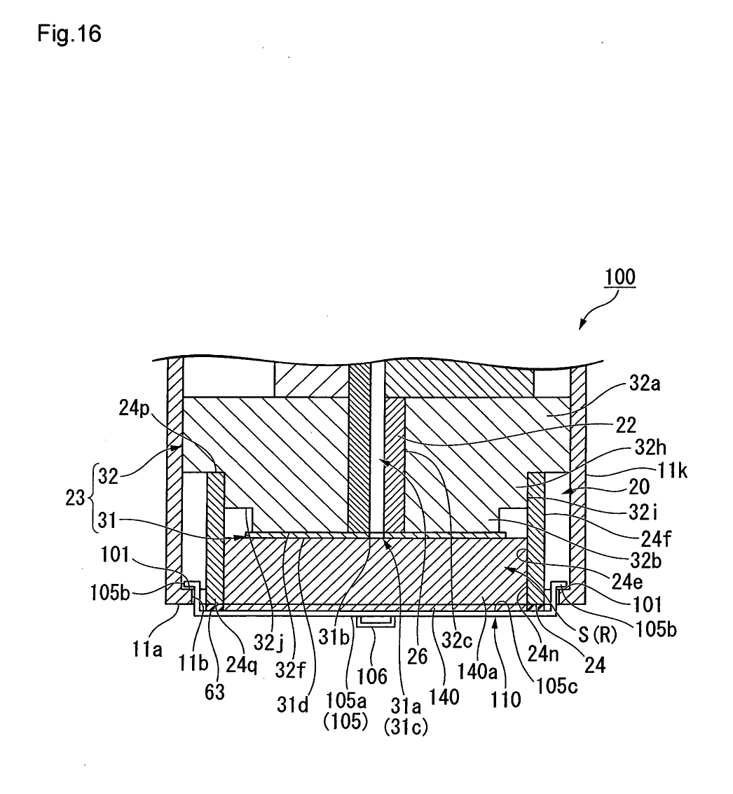

Next, a second embodiment of the present invention is described. FIG. 15 is a schematic structural view of an ink jet head 100 according to the second embodiment viewed from a right side, and FIG. 16 is a sectional view taken along the line IV-IV of FIG. 15.

The ink jet head 100 is different in that, while the above-mentioned opening and closing mechanism of the first embodiment is of a door type, the opening and closing mechanism of the ink jet head 100 is of a shutter type, and includes an opening and closing mechanism 110 and an absorber 140 provided on the opening and closing mechanism 110.

It is to be noted that like numerals and symbols are used to designate like or identical members in the first embodiment described above, and description thereof is omitted.

As illustrated in FIGS. 15 and 16, the opening and closing mechanism 110 of the ink jet head 100 of this embodiment includes a pair of guide portions 101, a shutter 105 supported between the guide portions 101, and the seal member 63 provided on a back surface 105c of the shutter 105 for sealing a gap between the shutter 105 in a state of closing the wall portion release opening 24n and the front end portion 24q side of the wall portion 24.

The guide portions 101 are provided from an upper portion of the case 11 to a lower surface of the case 11 utilizing a portion having the exposure hole 11b of the case 11 formed therein which protrudes toward the inside.

The shutter 105 is housed in inside space of the guide portions 101, that is, space between the wall portion 24 and the case 11. The shutter 105 is a flexible thin plate, and includes a shutter main body 105a for covering the wall portion release opening 24n and engaging portions 105b formed by bending both sides of the shutter main body 105a in a width direction for engaging with the guide portions 101. The shutter 105 is formed to be vertically (from a lower end to an upper end of the wall portion release opening 24n) slidable from the lower surface of the case 11 to the upper portion of the wall portion 24 with the engaging portions 105b thereof being guided by the guide portions 101. More specifically, when the shutter 105 is in a state of being disposed below the case 11 in the inside space of the guide portions 101, the shutter 105 is in an open state, and the wall portion release opening 24n communicates and the nozzle holes 31a are exposed to the outside. On the other hand, when the shutter 105 is in a state of being disposed so as to cover from the front end portion 24q side of the wall portion 24, the shutter 105 is in a closed state, and is formed to close the wall portion release opening 24n such that the space S between the wall portion 24 and the nozzle plate 31 forms closed space.

A grip portion 106 is provided on the side of one end of a front surface of the shutter 105, and the above-mentioned shutter 105 may be slid by operating the grip portion 106. Further, a water-repellent film (not shown) is formed by fluorine resin coating or Teflon (registered trademark) plating described above on a portion of the front surface of the shutter 105 which is opposed to the nozzle plate 31 in the closed state.

The absorber 140 is stuck to the whole of a surface of the back surface 105c of the shutter 105 which is exposed to the space S in the closed state of the opening and closing mechanism 110, in other words, to an inner surface surrounded by the seal member 63. A tip portion (on an upper side in the closed state of the guide portions 101) of the absorber 140 extends out in a direction of the normal to the width of the absorber 140 (horizontal direction in FIG. 12), and the tip portion has a wiper portion 140a which is brought into contact with the plate surface 31d of the nozzle plate 31.

More specifically, by carrying out the sliding operation (opening and closing operation) of the shutter 105, the wiper portion 140a follows the operation and vertically slides on the plate surface 31d of the nozzle plate 31, which causes the tip portion of the wiper portion 140a to be in sliding contact with the periphery of the nozzle holes 31a in the plate surface 31d of the nozzle plate 31.

In this way, according to this embodiment, because the wall portion release opening 24n may be opened and closed by sliding the shutter 105, compared with the structure in which the wall portion release opening 24n is opened and closed by rotating the door 62 (see FIG. 8) as in the first embodiment, the movable range of the opening and closing mechanism 110 in the direction of the normal to the surface of the nozzle cap 32 is small. More specifically, space used for placing the opening and closing mechanism 110 may be reduced. Therefore, the space factor may be further improved to improve the flexibility in designing the ink jet recording apparatus.

Further, even if the shutter 105 is formed to be slidable in the direction of arrangement of the nozzle column 31c, the movable space of the shutter 105 below the nozzle body 23 may be made minimum. Therefore, the space factor of the ink jet head 100 may be further improved to improve the flexibility in designing the ink jet recording apparatus.

Further, because the wiper portion 140a is in sliding contact with the surface of the nozzle body 23 following the sliding operation (opening and closing operation) of the shutter 105, the excess ink Y attached to the surface of the nozzle body 23 and the excess ink Y which protrudes from the nozzle orifices 31b of the nozzle holes 31a due to surface tension may be collected at the same time of opening and closing the shutter 105. This makes it possible to effectively use the space S of the wall portion 24 to improve the space factor. Further, because a wiper effect may be produced simultaneously with the opening and closing operation of the shutter 105, the operating efficiency may be improved without separately providing a wiping step after the ink I is filled.

It is to be noted that, as a modified example of the second embodiment described above, it is also possible to stop the shutter 105 in an engaged state halfway through the slide to be held with only the upper end portion of the wall portion release opening 24n being released. In this case, by releasing only the upper end portion of the wall portion release opening 24n from a state in which the wall portion release opening 24n is completely closed, the space S between the wall portion 24 and the nozzle plate 31 communicates with the outside to be released to the atmosphere. More specifically, the opening and closing mechanism may materialize the atmosphere release portion, which eliminates the necessity to provide the atmosphere release portion separately. Therefore, the space S may be released to the atmosphere without providing the atmosphere communication hole 11h, the atmosphere release flow path 33, and the atmosphere release valve 55 as in the first and second embodiments and without leakage of the excess ink Y which accumulates in the space S. This allows a simpler structure of the ink jet head 100 to reduce the manufacturing cost.

### Third Embodiment

Next, a third embodiment of the present invention is described. It is to be noted that like numerals and symbols are used to designate like or identical members in the first embodiment described above, and description thereof is omitted.

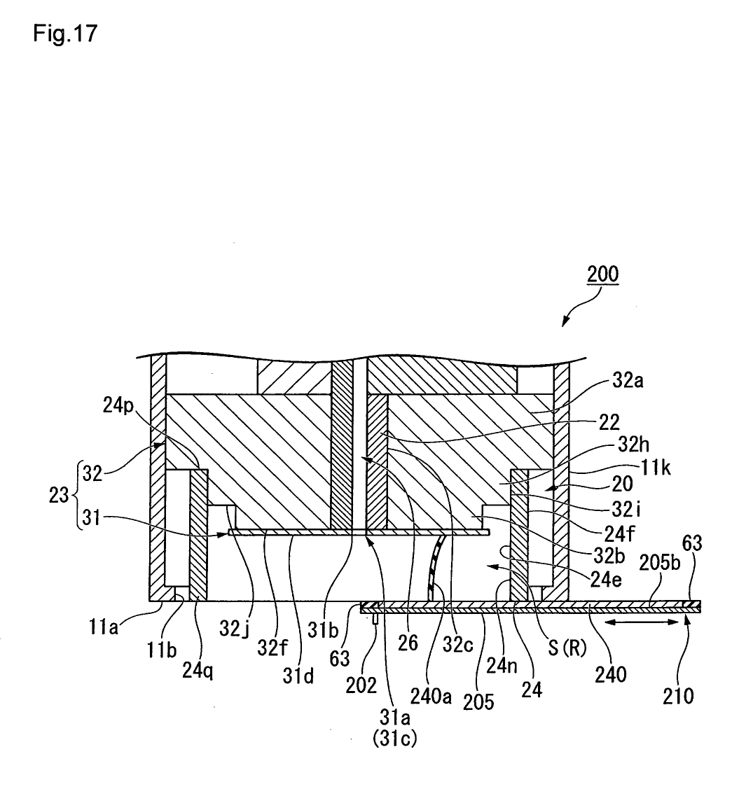

FIG. 17 is an enlarged sectional view of a principal part of an ink jet head 200 according to the third embodiment.

The ink jet head 200 is different in that its opening and closing mechanism is, different from the above-mentioned opening and closing mechanisms 60 and 110, of a sliding door type, and includes an opening and closing mechanism 210 and an absorber 240.

As illustrated in FIG. 17, the opening and closing mechanism 210 of the ink jet head 200 of this embodiment includes a shutter 205 supported by guide portions (not shown) and the seal member 63.

The shutter 205 is a thin plate which is formed such that the area thereof is larger than the area of the opening of the wall portion release opening 24n and is formed to be guided by guide portions (not shown) provided in upper and lower portions of the case 11 and to be slidable along a width direction (in a direction of an arrow of FIG. 17) of the wall portion 24. More specifically, when the shutter 205 is in an open state, the wall portion release opening 24n is released and the nozzle holes 31a are exposed to the outside. On the other hand, when the shutter 205 is in a closed state, the shutter 205 is disposed so as to cover the wall portion release opening 24n, and is formed to close the wall portion release opening 24n such that the space S between the wall portion 24 and the nozzle plate 31 forms closed space.

A grip portion 202 is provided on a front surface of the shutter 205, and the above-mentioned shutter 205 may be slid by operating the grip portion 202. Further, a water-repellent film (not shown) is formed by fluorine resin coating or Teflon (registered trademark) plating described above on the back surface of the shutter 205.

The absorber 240 is stuck to the whole of a back surface 205b of the shutter 205 which is exposed to the space S in the closed state of the opening and closing mechanism 210, in other words, to an inner surface surrounded by the seal member 63. The absorber 240 is provided in the direction of the long side along an end edge in, the width direction and extends out in a direction of the normal, and a tip portion thereof has a wiper portion 240a which is in contact with the plate surface 31d of the nozzle plate 31.

In this way, according to this embodiment, when the nozzle column 31c is disposed in the vertical direction, the shutter 205 does not move downward. This eliminates the necessity to provide below the nozzle body 23 space for the shutter 205 to move. Therefore, compared with a case in which the shutter is formed to be slidable in the direction of arrangement of the nozzle column 31c, the nozzle column 31c may be located lower. Accordingly, the space factor may be further improved to improve the flexibility in designing the ink jet recording apparatus 1.

Further, because the wiper portion 240a is in sliding contact with the plate surface 31d of the nozzle plate 31 following the opening and closing operation of the shutter 205, the excess ink Y attached to the surface of the nozzle plate 31 and the excess ink Y which protrudes from the nozzle orifices 31b of the nozzle holes 31a due to surface tension may be collected at the same time of opening and closing the shutter 205. This makes it possible to effectively use the space S of the wall portion 24 to improve the space factor. Further, because a wiper effect maybe produced simultaneously with the opening and closing operation of the shutter 205, the operating efficiency may be improved without separately providing a wiping step after the ink I is filled.

Further, according to this embodiment, because the absorber 240 is in sliding contact with the plate surface 31d of the nozzle plate 31 following the opening and closing operation of the shutter 205, the excess ink Y attached to the plate surface 31d of the nozzle plate 31 and the excess ink Y which protrudes from the nozzle orifices 31b of the nozzle holes 31a due to surface tension may be collected at the same time of opening and closing the shutter 205. This makes it possible to effectively use the space S to improve the space factor. Further, because a wiper effect may be produced simultaneously with the opening and closing operation of the shutter 205, the operating efficiency may be improved without separately providing a wiping step after the ink I is filled.

### Modified Example of Third Embodiment

Next, a modified example of this third embodiment is described. It is to be noted that like numerals and symbols are used to designate like or identical members in the first embodiment described above and in the ink jet head 200, and description thereof is omitted.

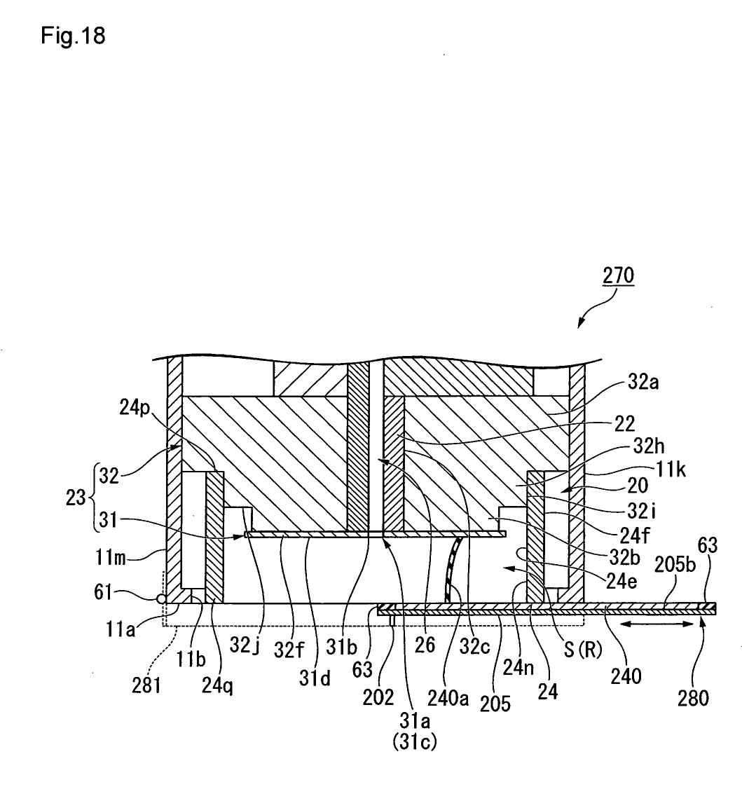

FIG. 18 is an enlarged sectional view of a principal part of an ink jet head 270 as a modified example of the ink jet head 200. The ink jet head 270 is different from the ink jet head 200 in that its opening and closing mechanism is a hybrid of a door type and a sliding door type, and includes an opening and closing mechanism 280 and the absorber 240.

The opening and closing mechanism 280 includes the hinge portion 61 one end of which is coupled to a side surface 11m of the case 11, guide portions 281 provided in upper and lower portions of the case 11 and coupled to the other end of the hinge portion 61, the shutter 205 supported by the guide portions 281, and the seal member 63.

According to the structure, by rotating the guide portions 281 via the hinge portion 61, the opening and closing operation of the door 62 maybe carried out smoothly. Further, because the absorber 240 is in sliding contact with the plate surface 31d of the nozzle plate 31 following the opening and closing operation of the shutter 205, the excess ink Y attached to the plate surface 31d of the nozzle plate 31 and the excess ink Y which protrudes from the nozzle orifices 31b of the nozzle holes 31a due to surface tension may be collected at the same time of opening and closing the shutter 205.

It is to be noted that the operation procedure or the shapes and combinations of the structural members described in the above-mentioned embodiments are only exemplary, and various modifications based on design requirements and the like, which fall within the gist of the present invention, are possible.

For example, in the above-mentioned embodiments, the nozzle body 23 is formed of the nozzle plate 31 and the nozzle cap 32 and the wall portion 24 is provided for the nozzle cap 32, but the wall portion 24 may be provided for the nozzle plate 31 on condition that the suction port 15a is open to the space S.

Further, in the above-mentioned embodiments, the suction port 15a is formed to fit into the discharge hole 32d formed in the nozzle cap 32, but the discharge hole 32d may be formed in the nozzle plate 31, or, the suction flow path 15 maybe connected to the discharge hole 32d and the discharge hole 32d may be the suction port.

Further, in the above-mentioned embodiments, the ink jet recording apparatus is formed with the ink jet head being fixed, but it is also possible to form the ink jet recording apparatus with the ink jet head being movable. More specifically, by adopting an ink jet head according to the present invention, an ink jet recording apparatus which eliminates the necessity of a cap for suction under negative pressure may be achieved.

Further, in the above-mentioned embodiments, the arrangement of the nozzle column 31c of the ink jet head 10 is provided in the direction of gravity and the openings of the nozzle holes 31a are provided in the horizontal direction, but the present invention is not limited thereto. The openings of the nozzle holes 31a may be provided in the direction of gravity and the nozzle column 31c may be provided to extend in the horizontal direction.

Further, in the above-mentioned embodiments, the suction pump is operated in the initial filling and in the cleaning, but there is a case in which the ink I droops from the nozzle holes 31a even when printing is carried out, and the ink I in such a case may be collected.

Further, in the opening and closing mechanism 60 according to the second embodiment, the hinge portion 61 protrudes from the front surface portion 11a of the case 11 and the front end portion 24q in a direction which is substantially orthogonal to the nozzle plate 31, but the hinge portion 61 is not necessarily required to be formed to protrude. More specifically, the state may be that there is no structure in a direction from the front surface portion 11a of the case 11 and the front end portion 24q toward the box D. Although not shown, in this case, the hinge portion 61 is formed on the side surface 11k of the case 11 and the hinge portion 61 is formed not to protrude from the case 11 toward the box D. Further, as the opening and closing operation requires, the shape of the door 62 may be changed.

Further, in the second embodiment, also, by providing the guide portions 101 with which the engaging portions 105b engage at the front end portion 24q, an embodiment in which the shutter 105 does not extend beyond the front surface portion 11a of the case 11 toward the box D may be achieved.

Further, in the third embodiment, also, by providing the guide portions (not shown) in the wall portion 24, an embodiment in which the shutter 205 does not extend beyond the front surface portion 11a of the case 11 toward the box D may be achieved.

By the structures described above, the distance between the front surface portion 11a of the case 11 and the box D may be made smaller, and thus, the printing precision may be improved.

Further, the opening and closing operation of the lid member may be done automatically or manually.

Further, in the above-mentioned first embodiment, the suction port 15a is formed to be open to the drainage flow path F formed in the absorber 40, but the drainage flow path F is not necessary required to be provided. On the contrary, the drainage flow path F may be formed to be provided in the absorber 140 in the second embodiment or in the absorber 240 in the third embodiment to which the suction port 15a is open. In those cases, the suction port 15a may be formed to be moved, for example, the tube forming the suction flow path 15 may be formed to be moved to pierce the absorber 140 or 240.

Further, as illustrated in FIGS. 6 and 7, in the head chip 20 in this embodiment, the open hole 22c is open to the whole long grooves 26, but the present invention is not limited thereto. For example, slits which communicate with every other long groove 26 may be formed in the ink chamber plate 22 to form the long grooves 26 into which the ink I is introduced and the long grooves 26 into which the ink I is not introduced. By adopting this form, even if the ink I is conductive, for example, the plate-like electrodes 28 on adjacent side walls 27 do not establish a short circuit and independent ink discharge may be achieved.

More specifically, the head chip described in this embodiment is not specifically limited, and a nonconductive oil-based ink, a conductive water-based ink, a solvent ink, an UV ink, or the like may be used. By forming the liquid jet head in this way, inks having any properties may be used. In particular, a conductive ink may be used without problems and the added value of the liquid jet recording apparatus may increase. It is to be noted that other actions and effects may be produced similarly.

Further, in the above-mentioned embodiments, as illustrated in FIG. 2, the excess ink Y sucked by the suction pump 16 is discharged to the waste liquid tank E, but the present invention is not limited thereto. For example, a structure connected to the flow path on the side of the outlet of the suction pump 16 may be not a waste liquid tank but the ink tank 51. More specifically, the excess ink Y sucked by the suction pump 16 may be supplied to the ink tank 51 and the ink may be supplied from the ink tank 51 to the ink jet head 10 as the ink I. By adopting this form, the excess ink Y may be reused as the ink I.

In addition to this structure, in reusing the excess ink Y, a filter member may be provided in the flow path from the suction pump 16 to the ink tank 51. By adopting this structure, impurities contained in the excess ink Y may be removed and ink in an appropriate state may be supplied to the ink tank 51.

Further, in reusing the excess ink Y, a deaerator may be provided in the flow path from the suction pump 16 to the ink tank 51. By adopting this structure, air bubbles contained in the excess ink Y may be removed and ink in an appropriately deaerated state may be supplied to the ink tank 51.

However, the structures described above are not necessarily required to be used and may be appropriately used according to the specifications of a droplet jet recording apparatus.

### DESCRIPTION OF SYMBOLS

1 . . . ink jet recording apparatus (liquid jet recording apparatus)

10, 70, 80, 90, 95, 100, 200, 270 . . . ink jet head (liquid jet head)

11 . . . case

11h . . . atmosphere communication hole (atmosphere release portion)

12 . . . liquid supply system

15 . . . suction flow path

15a . . . suction port

16 . . . suction pump (suction device)

21 . . . ceramic piezoelectric plate (actuator)

23 . . . nozzle body (jetting body)

24 . . . wall portion

24n . . . wall portion release opening (opening)

26 . . . long groove (pressure generating chamber)

31a . . . nozzle hole (jetting hole)

31b . . . nozzle orifice (liquid nozzle)

31c . . . nozzle column (jetting hole column)

31d . . . plate surface (opening surface)

33 . . . atmosphere release flow path (atmosphere release portion)

40, 41, 42, 43, 44, 140, 240 . . . absorber

40a . . . contact surface

40b, 41b, 42b . . . groove portion

43a . . . slit communicating portion (communicating portion)

44c . . . recessed communicating portion (communicating portion)

60, 110, 210, 280 . . . opening and closing mechanism

61 . . . hinge portion

62 . . . door (lid member)

62b . . . back surface

63 . . . seal member

105, 205 . . . shutter (lid member)

140a, 240a . . . wiper portion

D . . . box (recording medium)

F . . . drainage flow path

I . . . ink (first liquid)

R . . . negative pressure chamber

W . . . cleaning liquid (second liquid)

1. A liquid jet head including a jetting body having a jetting hole column formed of a plurality of jetting holes, a plurality of pressure generating chambers which are paired with and communicate with the plurality of jetting holes, respectively, a liquid supply system for supplying a first liquid to the plurality of pressure generating chambers and the plurality of jetting holes, and an actuator disposed adjacent to the plurality of pressure generating chambers, the actuator being driven to pressurize the plurality of pressure generating chambers, thereby causing the first liquid to be jetted from liquid nozzles of the plurality of jetting holes,
the liquid jet head comprising:
a wall portion provided so as to surround the jetting body and having an opening opposed to the plurality of jetting holes;
an opening and closing mechanism having a lid member which is capable of opening and closing the opening formed by the wall portion, for, in a closed state, closing the opening to form closed space inside the wall portion and for, in an open state, releasing the opening to expose the plurality of jetting holes to outside;
an absorber provided on a back surface of the lid member, for absorbing the first liquid which overflows from the plurality of jetting holes;
a suction flow path which has a suction port that is open to an inside of the wall portion to communicate with the closed space and which is connected to an outside suction device; and
an atmosphere release portion which is switchable between release of the closed space to the outside and interruption thereof.

2. A liquid jet head according to claim 1, wherein,
when the jetting hole column is disposed in the vertical direction,
the suction port is open below the jetting hole column in the jetting body, and
the atmosphere release portion is provided above and along a direction of arrangement of the jetting hole column.

3.-18. (canceled)

19. A method of filling liquid into a liquid jet head, the liquid jet head including a jetting body having a jetting hole column formed of a plurality of jetting holes, a plurality of pressure generating chambers which are paired with and communicate with the plurality of jetting holes, respectively, a liquid supply system for supplying a first liquid to the plurality of pressure generating chambers and the plurality of jetting holes, and an actuator disposed adjacent to the plurality of pressure generating chambers, the actuator being driven to pressurize the plurality of pressure generating chambers, thereby causing the first liquid to be jetted from liquid nozzles of the plurality of jetting holes,
the liquid jet head comprising:
a wall portion provided so as to surround the jetting body and having an opening opposed to the plurality of jetting holes;
an opening and closing mechanism having a lid member which is capable of opening and closing the opening formed by the wall portion, for, in a closed state, closing the opening to form closed space inside the wall portion and for, in an open state, releasing the opening to expose the plurality of jetting holes to outside;
an absorber provided on a back surface of the lid member, for absorbing the first liquid which overflows from the plurality of jetting holes;
a suction flow path which has a suction port that is open to an inside of the wall portion to communicate with the closed space and which is connected to an outside suction device; and
an atmosphere release portion which is switchable between release of the closed space to the outside and interruption thereof,
the method of filling liquid into a liquid jet head comprising the steps of:
in the closed state of the opening and closing mechanism, carrying out interruption by the atmosphere release portion and carrying out suction filling of the first liquid from the supply source into the plurality of pressure generating chambers and the plurality of jetting holes by the outside suction device via the suction flow path; and
after the filling of the first liquid, in the closed state of the opening and closing mechanism, releasing the atmosphere release portion and sucking by the outside suction device an excess of the first liquid existing in the closed space.
